(19) United States
(12) Patent Application Publication
(10) Pub. No.: US 2021/0039476 A1
(43) Pub. Date: Feb. 11, 2021

(54) VEHICLE CABIN AIR CONDITIONING SYSTEM

(71) Applicant: DENSO CORPORATION, Kariya-city (JP)

(72) Inventors: Tatsuhiro SUZUKI, Kariya-city (JP); Michio NISHIKAWA, Kariya-city (JP); Shigeru KAWANO, Kariya-city (JP); Akane KURODA, Kariya-city (JP)

(21) Appl. No.: 17/080,157

(22) Filed: Oct. 26, 2020

Related U.S. Application Data
(63) Continuation of application No. PCT/JP2019/015914, filed on Apr. 12, 2019.

(30) Foreign Application Priority Data
May 7, 2018 (JP) 2018-089386

(51) Int. Cl. B60H 1/32; B60H 1/00

(52) U.S. Cl. CPC B60H 1/3205; B60H 1/00207; B60H 2001/00221; B60H 1/3227; B60H 1/00285

(57) ABSTRACT

A vehicle cabin air conditioning system has an individual air conditioner for conditioning air in a target space in a cabin. The individual air conditioner has a blower, a suction port, a heat generator, and a supply port. The heat generator concurrently generates cold heat and warm heat inside the housing. At least one of the cold air cooled with the cold heat and the warm air heated with the warm heat is supplied from the supply port to the target space. The vehicle cabin air conditioning system has a thermal load reducing unit and a supply flow path. The thermal load reducing unit adjusts the temperature of air sucked from the suction port in order to reduce the thermal load in the heat generator. The supply flow path guides the air controlled in temperature by the thermal load reducing unit to the suction port.

### CROSS REFERENCE TO RELATED APPLICATIONS

The present application is a continuation application of International Patent Application No. PCT/JP2019/015914 filed on Apr. 12, 2019, which designated the U.S. and claims the benefit of priority from Japanese Patent Application No. 2018-89386 filed on May 7, 2018. The entire disclosures of all of the above applications are incorporated herein by reference.

### TECHNICAL FIELD

The present disclosure relates to a vehicle cabin air conditioning system.

### BACKGROUND

There have been conventionally developed various techniques relating to a cabin air conditioning in order to improve comfort of an occupant inside a cabin of a vehicle. Currently, as one of such technologies, a seat air conditioner conditions air around a seat in the cabin.

### SUMMARY

According to an aspect of the present disclosure, a vehicle cabin air conditioning system includes an individual air conditioner for conditioning air in a target space predetermined air inside the cabin. The individual air conditioner has a blower, a suction port, a heat generator, and a supply port. The blower is arranged inside the housing. Air is drawn into the housing through the suction port when the blower is operated. The heat generator concurrently generates cold heat for cooling air blown by the blower and warm heat for heating the air inside the housing. The supply port supplies at least one of the cold air obtained by cooling the air with the cold heat by the heat generator and the warm air obtained by heating the air with the warm heat by the heat generator to the target space. The vehicle cabin air conditioning system further includes a thermal load reducing unit that adjusts a temperature of the air sucked from the suction port in order to reduce the thermal load in the heat generator, and a supply flow path to guide the air having the temperature adjusted by the thermal load reducing unit to the suction port.

### BRIEF DESCRIPTION OF DRAWINGS

FIG. 1 is an overall configuration diagram of a vehicle cabin air conditioning system according to an embodiment.

FIG. 2 is a perspective view of a seat air conditioner in the vehicle cabin air conditioning system.

FIG. 3 is a perspective view showing the seat air conditioner in which an upper cover is removed.

FIG. 4 is a perspective view showing the seat air conditioner in which a first blower and a second blower are removed.

FIG. 5 is a plan view showing an internal configuration of the seat air conditioner.

FIG. 6 is a cross-sectional view taken along a line VI-VI in FIG. 5.

FIG. 7 is a cross-sectional view taken along a line VII-VII in FIG. 5.

FIG. 8 is a plan view showing an internal configuration of the seat air conditioner in a heating mode.

FIG. 9 is a cross-sectional view taken along a line IX-IX in FIG. 8.

FIG. 10 is a cross-sectional view taken along a line X-X in FIG. 8.

FIG. 11 is a configuration diagram of an indoor air conditioner in the vehicle cabin air conditioning system.

FIG. 12 is a block diagram showing a control system of the vehicle cabin air conditioning system.

FIG. 13 is a flowchart showing controls in the vehicle cabin air conditioning system.

FIG. 14 is a Mollier diagram showing effects of thermal load reducing operation in the cooling mode.

FIG. 15 is a graph showing a change in the high-pressure side refrigerant in the cooling mode over time.

FIG. 16 is a Mollier diagram showing effects of thermal load reducing operation in the heating mode.

FIG. 17 is a configuration diagram showing a modification of the vehicle cabin air conditioning system.

FIG. 18 is an explanatory diagram showing a connection mode of a supply duct in the vehicle cabin air conditioning system.

FIG. 19 is a configuration diagram showing a vehicle cabin air conditioning system using a heater.

FIG. 20 is a configuration diagram showing a vehicle cabin air conditioning system using a seat heater.

FIG. 21 is a configuration diagram of a vehicle cabin air conditioning system arranged at a front side of the cabin.

### DETAILED DESCRIPTION

To begin with, examples of relevant techniques will be described.

Various technologies related to a cabin air conditioning have been developed in order to enhance comfort of passengers inside the cabin. At present, as one of such techniques, for example, a seat air conditioner is configured to improve comfort by conditioning air around a seat arranged in the cabin as a target space.

The seat air conditioner has a housing arranged between a seat bottom of the seat and a floor surface to house a vapor compression refrigeration cycle device and a blower.

In the seat air conditioner, cold air and warm air are generated by adjusting the temperature of air sucked from outside of the housing with the refrigeration cycle. Then, the seat air conditioner supplies one of the warm air heated by the condenser and the cold air cooled by the evaporator to the seat which is the target space, of the air having the temperature adjusted by the refrigeration cycle device, and exhausts the other to the outside of the housing.

As described above, in the seat air conditioner, the refrigeration cycle device and the like are housed inside the housing. For this reason, in the seat air conditioner, the physical size of each component is restricted by the size of the housing. The maximum performance of each component is also restricted.

Therefore, in the seat air conditioner, the air conditioning performance may be insufficient at the initial stage of the air conditioning operation. In this case, it may take time to provide conditioned air having a comfortable temperature.

In addition, the seat air conditioner is configured to suck in air around the housing to adjust the temperature. Therefore, depending on the arrangement of the housing in the cabin, even if the air in the entire cabin is conditioned by using an air conditioner for the cabin to cool the entire cabin, a convection of the temperature-controlled air will not go around the housing.

The housing of the seat air conditioner is arranged between the seat bottom of the seat and the floor surface. In this case, the temperature of the air taken in by the seat air conditioner does not change. Therefore, it takes time to provide conditioned air having a comfortable temperature.

The present disclosure provides a vehicle cabin air conditioning system having an individual air conditioner that conditions air for a target space defined in the cabin, to improve comfort quickly in an initial stage of air conditioning operation.

According to an aspect of the present disclosure, a vehicle cabin air conditioning system has an individual air conditioner for conditioning air in a target space predetermined inside the cabin. The individual air conditioner has a blower, a suction port, a heat generator, and a supply port.

The blower is arranged inside the housing. The suction port is defined to suck air into the housing when the blower operates. The heat generator concurrently generates cold heat for cooling the air blown by the blower and warm heat for heating the air inside the housing. The supply port supplies at least one of the cold air obtained by cooling the air with the cold heat generated by the heat generator and the warm air obtained by heating the air with the warm heat generated by the heat generator to the target space outside the housing.

The vehicle cabin air conditioning system further includes a thermal load reducing unit and a supply flow path. The thermal load reducing unit adjusts the temperature of the air sucked from the suction port in order to reduce the thermal load in the heat generator. The supply flow path guides the air having the temperature adjusted by the thermal load reducing unit to the supply port.

That is, according to the vehicle cabin air conditioning system, the air sucked into the housing from the suction port by the blower of the individual air conditioner can be controlled in temperature by the heat generator and supplied to the target space. Thus, the comfort of the target space can be improved by using the individual air conditioner.

Further, according to the vehicle cabin air conditioning system, the air with temperature adjusted by the thermal load reducing unit to reduce the thermal load of the individual air conditioner is guided to the suction port of the individual air conditioner through the supply flow path. As a result, the comfort can be efficiently improved by the individual air conditioner.

According to the vehicle cabin air conditioning system, in the initial stage of the air conditioning operation, the air that has passed through the thermal load reducing unit can be guided to the suction port. The heat generator can perform temperature control using the air whose temperature is adjusted so as to reduce the thermal load of the individual air conditioner. As a result, the vehicle cabin air conditioning system can quickly improve comfort in the target space.

Hereinafter, embodiments for implementing the present disclosure will be described referring to drawings. In the respective embodiments, parts corresponding to matters already described in the preceding embodiments are given reference numbers identical to reference numbers of the matters already described. The same description is therefore omitted depending on circumstances. In the case where only a part of the configuration is described in each embodiment, the other embodiments described above can be applied to the other part of the configuration. The present disclosure is not limited to combinations of embodiments which combine parts that are explicitly described as being combinable. As long as no problem is present, the various embodiments may be partially combined with each other even if not explicitly described.

Hereinafter, an embodiment will be described with reference to the drawings. In the following embodiment, identical or equivalent elements are denoted by the same reference numerals as each other in the drawings.

In order to facilitate understanding of the positional relationship of components in the embodiment, arrows indicating up, down, left, right, front and rear in the drawings represent an example of a standard corresponding to orthogonal coordinate systems (for example, X axis, Y axis, Z axis) in three-dimensional space.

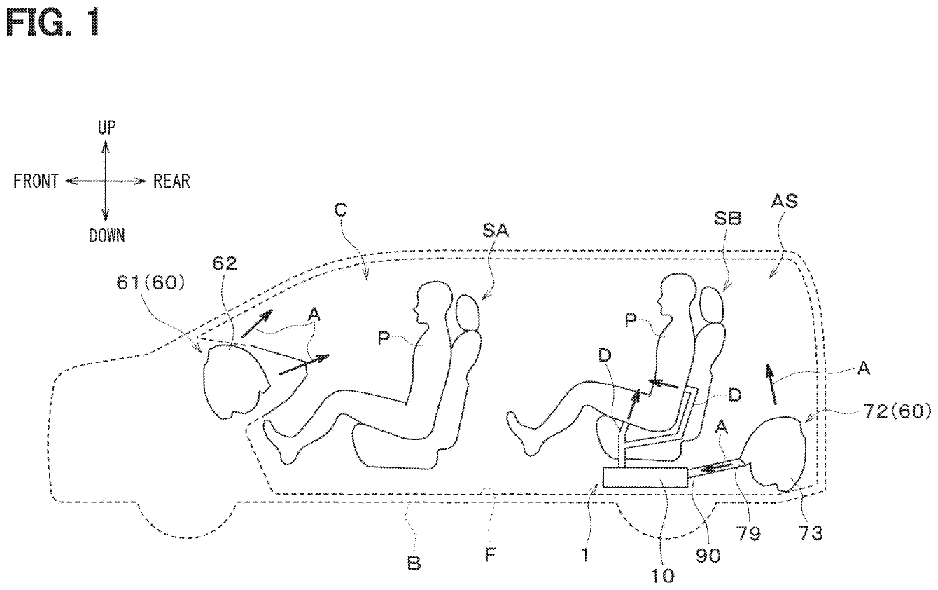

Specifically, the arrows indicating up and down, left and right, and front and rear in the drawings are defined with reference to the viewpoint of an occupant on the seat of the vehicle. In the respective drawings, front side and back side in the depth direction of the paper surface are defined with respect to this position as well. For example, the front side and the back side in the depth direction of the paper surface in FIG. 1 correspond to the left-right direction.

As shown in FIG. 1, a vehicle cabin air conditioning system AS according to an embodiment is applied to a hybrid vehicle, and includes a seat air conditioner 1 that conditions air in a seat disposed in a cabin C as a target space, and an indoor air conditioner 60 that conditions air in the entire cabin C.

The cabin C is provided with plural seats for passenger P. Each of the seats has a seat bottom and a backrest. The passenger P is on the seat bottom and in front of the backrest. The seats are arranged to be slidable in the front-rear direction within a predetermined range via a seat rail (not shown) arranged on the floor surface F of the cabin.

The seats include a front seat SA and a rear seat SB. The front seat SA is arranged on the front side of the cabin C, and corresponds to, for example, a driver seat or a passenger seat. The rear seat SB is arranged on the rear side of the cabin C and is located behind the front seat SA.

In the vehicle cabin air conditioning system AS according to the embodiment, as shown in FIG. 1, the seat air conditioner 1 is arranged to the rear seat SB, and the temperature-controlled air is supplied to a target space determined for the rear seat SB. The target space in this case means above the seat bottom of the rear seat SB and in front of the backrest. The target space indicates a range in which the passenger P is seated on the rear seat SB. That is, the seat air conditioner 1 corresponds to an individual air conditioner.

The seat air conditioner 1 supplies air whose temperature is adjusted by a refrigeration cycle device 20 or the like arranged inside the housing 10 to the target space via a seat duct D arranged in the rear seat SB. The seat air conditioner 1 can improve the comfort of the passenger P on the rear seat SB.

The housing 10 of the seat air conditioner 1 is attached to the seat bottom of the rear seat SB by an attachment member (not shown). Therefore, the seat air conditioner 1 is arranged so as to be movable in the front-rear direction with the sliding movement of the rear seat SB.

In the vehicle cabin air conditioning system AS according to the embodiment, the indoor air conditioner 60 includes a front seat air conditioning unit 61 and a rear seat air conditioning unit 72, to condition air entirely for the cabin C of the hybrid vehicle. The indoor air conditioner 60 has a cabin side refrigeration cycle 82, and supplies the conditioned air A whose temperature is adjusted in the cabin side refrigeration cycle 82 into the cabin C.

As shown in FIG. 1, a supply duct 90 is arranged between the seat air conditioner 1 and the rear seat air conditioning unit 72 of the indoor air conditioner 60. The supply duct 90 is an air flow path through which the conditioned air A blown from the rear seat air conditioning unit 72 of the indoor air conditioner 60 flows.

The vehicle cabin air conditioning system AS guides the conditioned air A controlled in temperature by the indoor air conditioner 60 through the supply duct 90 so as to reduce the thermal load of the refrigeration cycle device 20, thereby reducing the thermal load in the air conditioning operation of the seat air conditioner 1. The indoor air conditioner 60 functions as a thermal load reducing unit. A specific configuration of the vehicle cabin air conditioning system AS will be described with reference to the drawings.

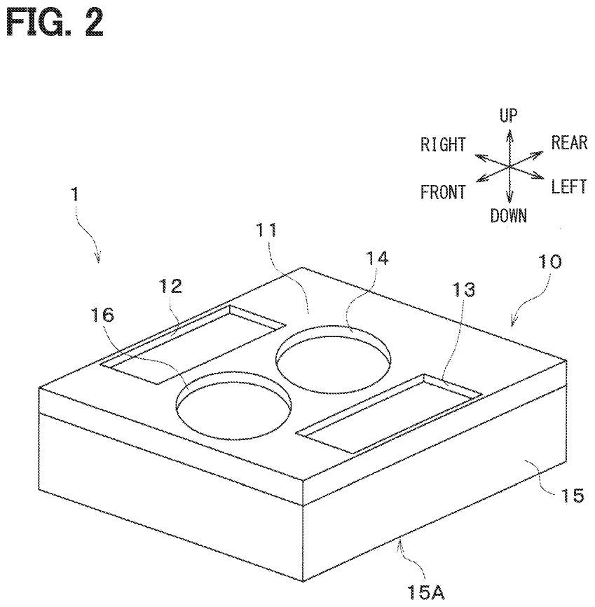

A specific configuration of the seat air conditioner 1 of the vehicle cabin air conditioning system AS will be described in detail with reference to FIGS. 2 to 10. As shown in FIGS. 2 to 4, the seat air conditioner 1 includes the vapor compression refrigeration cycle device 20, a first blower 30, a second blower 31, a warm air switching unit 35, and a cold air switching unit 40, which are housed inside the housing 10.

The refrigeration cycle device 20 of the seat air conditioner 1 can adjust the temperature of air blown by the operation of the first blower 30 and the second blower 31. The seat air conditioner 1 supplies the temperature-controlled air (for example, warm air WA, cold air CA) to the passenger P on the rear seat SB via the seat duct D arranged in the rear seat SB.

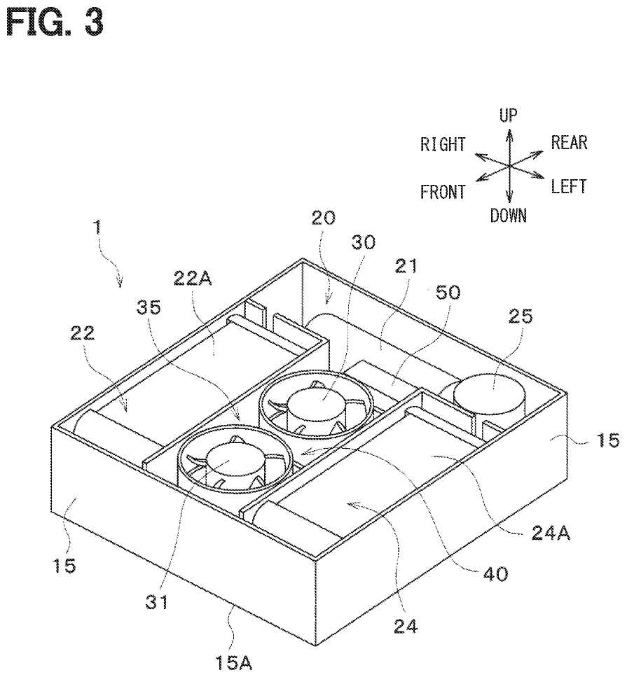

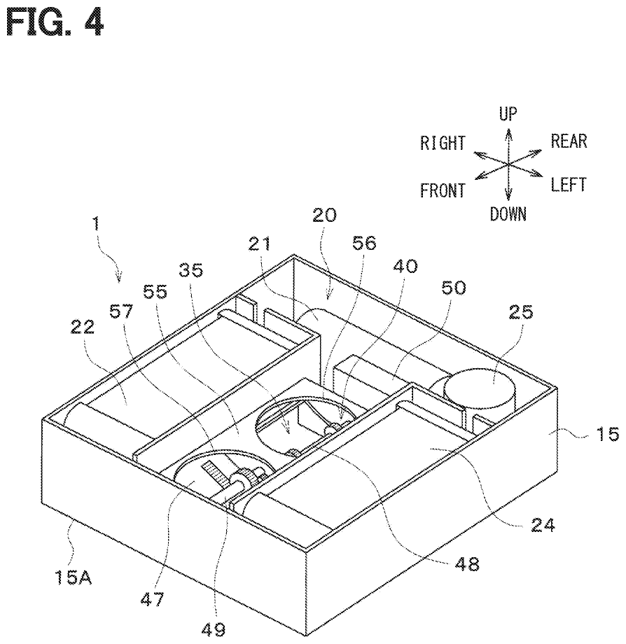

A specific configuration of the housing 10 will be described with reference to FIGS. 2 to 4. FIG. 3 shows a state in which the upper cover 11 is removed from FIG. 2, and FIG. 4 shows a state in which the first blower 30 and the second blower 31 are removed from FIG. 3.

The housing 10 of the seat air conditioner 1 is formed in a rectangular parallelepiped shape that can be arranged between the seat bottom of the rear seat SB and the cabin floor surface F. As shown in FIG. 2, the housing 10 has the upper cover 11 and the case body 15.

The upper cover 11 constitutes the upper surface of the housing 10, and is attached so as to close the opening of the box-shaped case body 15 having an open top. The upper cover 11 has a warm air vent 12, a cold air vent 13, a supply port 14, and an exhaust port 16.

The warm air vent 12 is opened in the right side of the upper cover 11. The warm air vent 12 is a ventilation port for sucking air outside the housing 10 (that is, air in the cabin C) into the housing 10 in response to the operation of the first blower 30.

The end of the supply duct 90 is arranged around the warm air vent 12. Therefore, the conditioned air A of the indoor air conditioner 60 is supplied to the warm air vent 12 via the supply duct 90. This will be described in detail later. The warm air vent 12 functions as a suction port.

As shown in FIGS. 2 to 10, a condenser 22 of the refrigeration cycle device 20 is arranged at a position below the warm air vent 12 inside the housing 10. The air sucked from the warm air vent 12 is heated by exchanging heat with high-pressure refrigerant when passing through the condenser 22, and is supplied as the warm air WA.

The cold air vent 13 is opened in the left side of the upper cover 11, and is arranged so as to be symmetrical to the warm air vent 12. Similar to the warm air vent 12, the cold air vent 13 is a ventilation port for sucking air outside the housing 10 into the inside with the operation of the first blower 30 and the like.

The end of the supply duct 90 is arranged around the cold air vent 13. Therefore, the conditioned air A of the indoor air conditioner 60 is supplied to the cold air vent 13 via the supply duct 90. This will be described in detail later. The cold air vent 13 functions as a suction port together with the warm air vent 12.

An evaporator 24 of the refrigeration cycle device 20 is arranged in a position below the cold air vent 13 inside the housing 10. The air sucked from the cold air vent 13 is cooled when passing through the evaporator 24 and supplied as the cold air CA.

The supply port 14 is opened at the rear-side center of the upper cover 11. The supply port 14 is a ventilation port for supplying air (for example, warm air WA, cold air CA) whose temperature is adjusted by the refrigeration cycle device 20 in the seat air conditioner 1 to the target space.

One end of the seat duct D is connected to the supply port 14. The seat duct D is arranged along both sides of the seat bottom and the backrest of the rear seat SB, and is configured to guide the warm air WA and the cold air CA to the space for the passenger P on the rear seat SB.

Further, the exhaust port 16 is opened at the front center of the upper cover 11. The exhaust port 16 is an opening through which a part of the air whose temperature is adjusted by the refrigeration cycle device 20 inside the housing 10 is discharged as exhaust gas. Therefore, the air blown from the exhaust port 16 is sent to the outside of the target space.

The case body 15 constitutes a main part of the housing 10, and is formed in a box shape with an open top. As shown in FIGS. 3 to 10, components such as the refrigeration cycle device 20 and the first blower 30 are arranged inside the case body 15.

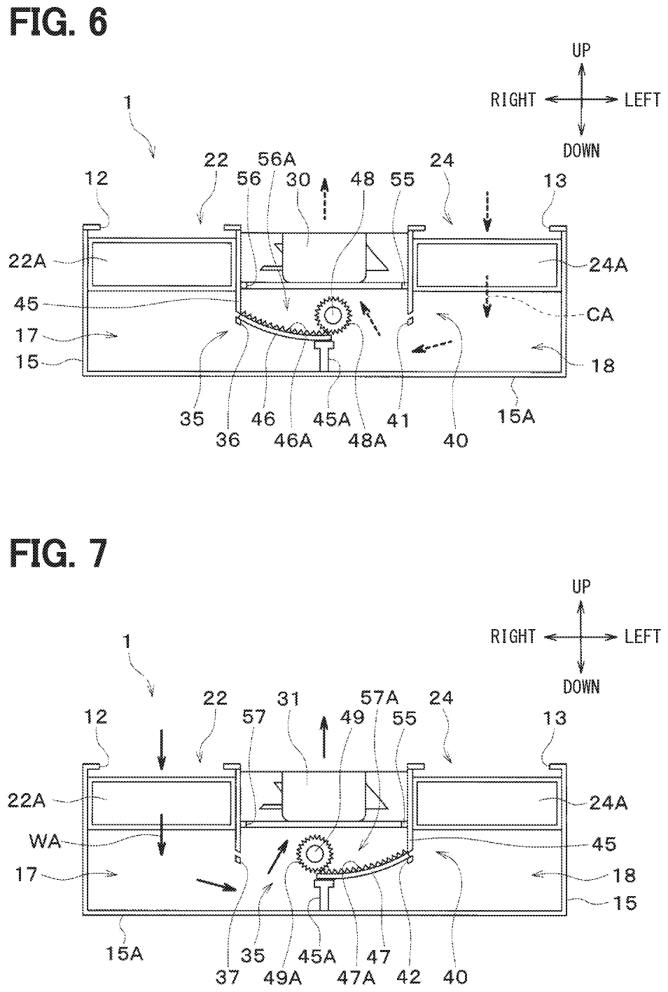

As shown in FIGS. 6 and 7, a warm air passage 17 and a cold air passage 18 are formed inside the case body 15. The warm air WA heated by the condenser 22 flows through the warm air passage 17. The cold air CA cooled by the evaporator 24 flows through the cold air passage 18. Each of the warm air passage 17 and the cold air passage 18 is configured between the housing bottom surface 15A of the case body 15 and the component.

As shown in FIG. 1, the housing 10 is arranged at a distance from the lower surface of the seat bottom of the rear seat SB. Therefore, the ends of the supply duct 90 and the seat duct D can be arranged with respect to the warm air vent 12, the cold air vent 13 and the supply port 14 on the upper surface of the housing 10.

Next, the configuration of the refrigeration cycle device 20 in the seat air conditioner 1 will be described with reference to the drawings. The refrigeration cycle device 20 is housed inside the housing 10 to form a vapor compression refrigeration cycle.

The refrigeration cycle device 20 includes a compressor 21, the condenser 22, a pressure reducing unit 23, the evaporator 24, and an accumulator 25. The refrigeration cycle device 20 cools or heats air blown to the target space of the rear seat SB by circulating refrigerant by the operation of the compressor 21. The refrigeration cycle device 20 corresponds to a heat generator that generates warm heat in the condenser 22 and cold heat in the evaporator 24 in parallel at the same time.

The refrigeration cycle device 20 employs an HFC-based refrigerant (specifically, R134a) as a refrigerant, and forms a vapor compression subcritical refrigeration cycle in which the high-pressure side refrigerant pressure does not exceed the critical pressure of refrigerant. HFO refrigerant (e.g., R1234yf) or a natural refrigerant (e.g., R744) may be employed as the refrigerant. Refrigerant oil for lubricating the compressor 21 is mixed into the refrigerant and a part of the refrigerant oil circulates through the cycle together with the refrigerant.

In the refrigeration cycle device 20, the compressor 21 draws, compresses, and discharges the refrigerant. The compressor 21 is configured as an electric compressor in which a fixed displacement type compression mechanism having a fixed discharge capacity is driven by an electric motor. As shown in FIGS. 3 and 4, the compressor 21 is located at the rear side in the case body 15. As the compression mechanism of the compressor 3, various compression mechanisms such as a scroll compression mechanism and a vane compression mechanism can be employed.

The operation (rotation number) of the electric motor of the compressor 21 is controlled by a control signal outputted from an air conditioning control unit 100 to be described later. A refrigerant discharge capacity of the compressor 21 is changed by controlling the rotation speed of the electric motor by the air conditioning control unit 100.

The inlet of the condenser 22 is connected to the discharge pipe through which the high-pressure refrigerant compressed by the compressor 21 is discharged. The condenser 22 has a heat exchange section 22A configured by stacking tubes and fins in a flat plate shape. Heat is exchanged between air passing through the heat exchange section 22A and the high-pressure refrigerant flowing through each of the tubes.

As shown in FIGS. 3 to 5, the condenser 22 is disposed on the right side of the case body 15, and is located below the warm air vent 12. The air sucked from the warm air vent 12 passes through the heat exchange section 22A of the condenser 22.

That is, heat is exchanged in the condenser 22 between the high-temperature and high-pressure refrigerant discharged from the compressor 21 and the air sucked from the warm air vent 12. Thus, the air is heated and provided as the warm air WA. That is, the condenser 22 operates as a heat exchanger for heating and functions as a radiator.

The heat exchange section 22A of the condenser 22 is formed in a flat plate shape having a longitudinal direction corresponding to the extending direction of the tubes and fins. As shown in FIGS. 3 to 10, the condenser 22 is arranged such that the longitudinal direction of the heat exchange section 22A is along the front-rear direction of the seat air conditioner 1.

As shown in FIGS. 6 and 7, the condenser 22 is arranged such that the heat exchange section 22A is located above the housing bottom surface 15A by a predetermined distance. The warm air WA that has passed through the heat exchange section 22A flows through a space formed below the condenser 22, and the space functions as a part of the warm air passage 17.

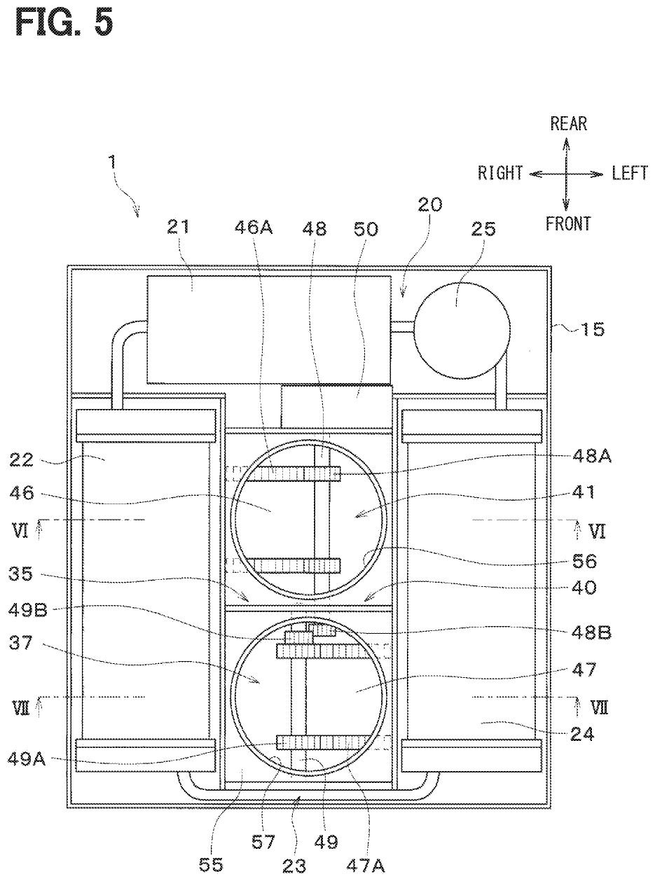

The pressure reducing unit 23 is connected to the outlet side of the condenser 22. The pressure reducing unit 23 is configured by a so-called fixed throttle, and decompresses the refrigerant flowing out from the condenser 22. As shown in FIG. 5, the pressure reducing unit 23 is arranged on the front side inside the case body 15.

In the seat air conditioner 1, a fixed throttle is used as the pressure reducing unit 23, but is not limited to this. Various structures can be used as the pressure reducing unit that can reduce the pressure of the refrigerant flowing out of the condenser 22. For example, a capillary tube may be adopted as the pressure reducing unit 23, or an expansion valve whose throttle opening can be controlled by a control signal from the control unit may be used as the pressure reducing unit 23.

The inlet side of the evaporator 24 is connected to the outlet side of the pressure reducing unit 23. The evaporator 24 has a heat exchange section 24A configured by stacking tubes and fins in a flat plate shape, to absorb heat from the air passing through the heat exchange section 24A, such that the low-pressure refrigerant flowing in each of the tubes is evaporated.

As shown in FIGS. 3 to 5, the evaporator 24 is arranged on the left side of the case body 15 and is located below the cold air vent 13. Therefore, in the seat air conditioner 1, the evaporator 24 is arranged inside the housing 10 with a space with respect to the condenser 22 in the left-right direction.

The air sucked from the cold air vent 13 passes through the heat exchange section 24A of the evaporator 24. That is, in the evaporator 24, heat is exchanged between the air sucked from the cold air vent 13 and the low-pressure refrigerant decompressed by the pressure reducing unit 23, such that the air is cooled into the cold air CA. In other words, the evaporator 24 operates as a heat exchanger for cooling and functions as a heat absorber.

The heat exchange section 24A of the evaporator 24 is formed in a flat plate shape having the longitudinal direction corresponding to the extending direction of the tubes and fins. As shown in FIGS. 3 to 7, the evaporator 24 is arranged such that the longitudinal direction of the heat exchange section 24A is along the front-rear direction of the seat air conditioner 1. As shown in FIGS. 6 and 7, the evaporator 24 is arranged such that the heat exchange section 24A is located above the housing bottom surface 15A by a predetermined distance. The cold air CA that has passed through the heat exchange section 24A flows in a space formed below the evaporator 24, and the space functions as a part of the cold air passage 18.

The accumulator 25 is connected to the outlet side of the evaporator 24, and is arranged on the left and rear side of the case body 15. The accumulator 25 separates the gas/liquid of the refrigerant flowing out from the evaporator 24, and stores the excess liquid phase refrigerant in the refrigeration cycle.

A suction pipe of the compressor 21 is connected to a gas-phase refrigerant outlet of the accumulator 25. The gas-phase refrigerant separated by the accumulator 25 is sucked into the compressor 21 through the suction pipe.

As shown in FIG. 3, the first blower 30 and the second blower 31 are arranged inside the housing 10. The first blower 30 includes an impeller having plural blades and an electric motor that rotates the impeller.

The first blower 30 is located on the rear side between the condenser 22 and the evaporator 24, and is located below the supply port 14. The first blower 30 can blow air to the target space of the rear seat SB via the supply port 14 and the seat duct D by rotating the impeller. That is, the first blower 30 is an example of blower.

The second blower 31 has an impeller and an electric motor, like the first blower 30. As shown in FIG. 3, the second blower 31 is arranged between the condenser 22 and the evaporator 24 so as to be adjacent to the front side of the first blower 30.

The second blower 31 is located below the exhaust port 16. The second blower 31 can blow air to outside of the target space via the exhaust port 16 by rotating the impeller. That is, the second blower 31 is an example of blower.

As shown in FIG. 4 and the like, a fan support 55 is arranged below the first blower 30 and the second blower 31. The fan support 55 is arranged between the condenser 22 and the evaporator 24, and has a first mounting opening 56 and a second mounting opening 57. As shown in FIGS. 4 to 7, the fan support 55 is arranged so as to be located at a predetermined height from the housing bottom surface 15A of the housing 10, and defines a space between the condenser 22 and the evaporator 24 into an upper part and a lower part.

The first blower 30 is attached to the first mounting opening 56 arranged on the rear side of the fan support 55. The second blower 31 is attached to the second mounting opening 57 arranged on the front side of the fan support 55 so as to be adjacent to the first mounting opening 56.

The first blower 30 can suck air below the fan support 55 through the first mounting opening 56 and supply the air to the supply port 14. The second blower can take in air below the fan support 55 through the second mounting opening 57 and supply the air to the exhaust port 16.

The configurations of the warm air switching unit 35 and the cold air switching unit 40 in the seat air conditioner 1 will be described with reference to the drawings.

FIG. 6 shows a cross-sectional view taken along a line VI-VI in FIG. 5, and shows an example of the flow of air (cold air CA) by the first blower 30. FIG. 7 shows a cross-sectional view taken along a line VII-VII in FIG. 5, and shows an example of the flow of air (warm air WA) by the second blower 31.

As shown in FIG. 4, the seat air conditioner 1 includes the warm air switching unit 35 and the cold air switching unit 40 between the condenser 22 and the evaporator 24, below the first blower 30 and the second blower 31. The warm air switching unit 35 is a mechanism for switching the destination of the warm air WA heated by the condenser 22. The cold air switching unit 40 is a mechanism for switching the destination of the cold air CA cooled by the evaporator 24.

The warm air switching unit 35 and the cold air switching unit 40 are configured to include a frame member 45 disposed below the fan support 55, a supply slide door 46, an exhaust slide door 47, and a drive motor 50.

That is, the warm air switching unit 35 and the cold air switching unit 40 are arranged inside the housing 10, between the condenser 22 at the right side and the evaporator 24 at the left side. The warm air switching unit 35 between the condenser 22 and the evaporator 24 is located on the right side (adjacent to the condenser 22), and the cold air switching unit 40 between the condenser 22 and the evaporator 24 is located on the left side (adjacent to the evaporator 24).

As shown in FIGS. 6 and 7, the frame member 45 is arranged below the fan support 55 between the condenser 22 and the evaporator 24 and extends along the front-rear direction. The frame member 45 is formed in an arc shape that bulges downward with respect to a cross section perpendicular to the front-rear direction.

A partition portion 45A is formed at a lower end portion of the frame member 45 that swells in an arc shape. The partition portion 45A is formed in a wall shape that closes a space between the lower end portion of the frame member 45 and the inner surface of the housing bottom surface 15A, and extends in the front-rear direction. That is, the space below the frame member 45 is divided into left and right by the partition portion 45A.

A space below the frame member 45 at the right side of the partition portion 45A communicates with a space below the condenser 22 and forms a part of the warm air passage 17. Similarly, a space below the frame member 45 at the left side of the partition portion 45A communicates with a space below the evaporator 24 and forms a part of the cold air passage 18.

A partition rib is formed in the center of the frame member 45 in the front-rear direction to partition the space between the fan support 55 and the frame member 45 into front and rear parts. A space on the rear side of the partition rib communicates with the first mounting opening 56 and functions as a supply space 56A into which the air supplied from the supply port 14 flows. A space on the front side of the partition rib communicates with the second mounting opening 57 and functions as an exhaust space 57A into which the air blown from the exhaust port 16 flows.

The warm air supply opening 36 and the warm air exhaust opening 37 that form the warm air switching unit 35 are arranged adjacent to each other in the front-rear direction, on the right side of the partition portion 45A of the frame member 45. The warm air supply opening 36 is formed in the rear and right side of the frame member 45, by which the supply space 56A and the warm air passage 17 communicate with each other. The warm air exhaust opening 37 is formed in the front and right side of the frame member 45, by which the exhaust space 57A and the warm air passage 17 communicate with each other.

As shown in FIGS. 6 and 7, the frame member 45 is formed in an arc shape that bulges downward as going to the center in the left-right direction. The warm air supply opening 36 and the warm air exhaust opening 37 are open at the right side of the frame member 45.

Therefore, the opening edges of the warm air supply opening 36 and the warm air exhaust opening 37 are formed so as to draw a downward arc as separating away from the right side of the housing 10 where the condenser 22 is arranged. As a result, the opening area of the warm air supply opening 36 and the warm air exhaust opening 37 is larger than that in case where, for example, the warm air supply opening 36 and the like is formed to cross the warm air passage 17 in the left-right direction (that is, horizontally).

As shown in FIGS. 5 to 7, the condenser 22 is arranged such that the longitudinal direction of the heat exchange section 22A is along the front-rear direction. In the warm air switching unit 35, the warm air supply opening 36 and the warm air exhaust opening 37 are arranged side by side in the front-rear direction.

As a result, in the seat air conditioner 1, with respect to the air that has passed through the heat exchange section 22A of the condenser 22, both the air volume that flows into the warm air supply opening 36 and the air volume that flows into the warm air exhaust opening 37 can be secured enough.

The cold air supply opening 41 and the cold air exhaust opening 42 that form the cold air switching unit 40 are arranged adjacent to each other in the front-rear direction, on the left side of the partition portion 45A in the frame member 45.

The cold air supply opening 41 is formed on the left and rear side of the frame member 45, by which the supply space 56A and the cold air passage 18 communicate with each other. As shown in FIG. 6, in the frame member 45, the cold air supply opening 41 is adjacent to the warm air supply opening 36 in the left-right direction.

The cold air exhaust opening 42 is formed on the left and front side of the frame member 45, by which the exhaust space 57A and the cold air passage 18 communicate with each other. As shown in FIG. 7, the cold air exhaust opening 42 is adjacent to the warm air exhaust opening 37 in the left-right direction, in the frame member 45.

The frame member 45 is formed in an arc shape that bulges downward toward the center in the left-right direction. The cold air supply opening 41 and the cold air exhaust opening 42 are formed on the left side of the frame member 45.

Therefore, the opening edges of the cold air supply opening 41 and the cold air exhaust opening 42 are formed so as to draw downward arc as separating away from the left side of the housing 10 where the evaporator 24 is arranged. Accordingly, the opening area of the cold air supply opening 41 and the cold air exhaust opening 42 is larger than that in case where the cold air supply opening 41 and the like are formed to cross the cold air passage 18 in the left-right direction (that is, horizontally).

As shown in FIGS. 5 to 7, the evaporator 24 is arranged such that the longitudinal direction of the heat exchange section 24A is along the front-rear direction. In the cold air switching unit 40, the cold air supply opening 41 and the cold air exhaust opening 42 are arranged side by side in the front-rear direction.

As a result, in the seat air conditioner 1, with respect to the air that has passed through the heat exchange section 24A of the evaporator 24, the air volume that flows into the cold air supply opening 41 and the air volume that flows into the cold air exhaust opening 42 can be secured.

The supply slide door 46 is movably attached to the rear side of the frame member 45. The supply slide door 46 is formed in a plate shape curved along the arc of the frame member 45, and has a size capable of closing the warm air supply opening 36 or the cold air supply opening 41.

The supply slide door 46 is slidably attached along the arc of the frame member 45 between the position where the warm air supply opening 36 is closed and the position where the cold air supply opening 41 is closed.

Therefore, in the seat air conditioner 1, the volume of the warm air WA flowing into the supply space 56A through the warm air supply opening 36 and the volume of the cold air CA flowing into the supply space 56A through the cold air supply opening 41 can be adjusted by moving the supply slide door 46. That is, the supply slide door 46 can adjust the proportion of the warm air WA and the cold air CA in the air supplied from the supply port 14.

The exhaust slide door 47 is movably attached to the front side of the frame member 45. The exhaust slide door 47 is formed in a plate shape curved along the arc of the frame member 45, and has a size capable of closing the warm air exhaust opening 37 or the cold air exhaust opening 42.

The supply slide door 46 is slidably attached along the arc of the frame member 45 between the position where the warm air exhaust opening 37 is closed and the position where the cold air exhaust opening 42 is closed.

Therefore, in the seat air conditioner 1, the volume of the warm air WA flowing into the exhaust space 57A through the warm air exhaust opening 37 and the volume of the cold air CA flowing into the exhaust space 57A through the cold air exhaust opening 42 can be adjusted by moving the exhaust slide door 47. That is, the exhaust slide door 47 can adjust the proportion of the warm air WA and the cold air CA in the air blown from the exhaust port 16.

As shown in FIG. 5 and the like, the drive motor 50 is arranged inside the housing 10. The drive motor 50 is a so-called servo motor, and functions as a drive source for slidingly moving the supply slide door 46 and the exhaust slide door 47. The drive motor 50 is operated based on a control signal from the air conditioning control unit 100.

A supply shaft 48 is connected to the drive shaft of the drive motor 50. The supply shaft 48 extends frontward from the drive motor 50 and has two gears 48A. The supply shaft 48 is arranged so as to traverse above the supply slide door 46 in the front-rear direction.

The upper surface of the supply slide door 46 has two tooth portions 46A extending in the left-right direction. The tooth portion 46A of the supply slide door 46 is formed so as to mesh with the teeth of the gear 48A of the supply shaft 48.

Therefore, the power generated by the drive motor 50 is transmitted to the supply slide door 46 via the gear 48A and the tooth portion 46A. That is, in the seat air conditioner 1, the supply slide door 46 can slide to a position in the left-right direction by controlling the operation of the drive motor 50 by the air conditioning control unit 100.

An exhaust shaft 49 is rotatably supported on the front side of the supply shaft 48. The exhaust shaft 49 extends frontward parallel to the supply shaft 48, and has two gears 49A.

As shown in FIG. 5, a transmission gear 48B is arranged at the front end portion of the supply shaft 48 and is configured to mesh with a driven gear 49B arranged at the rear end portion of the exhaust shaft 49. Therefore, the power generated by the drive motor 50 is transmitted to the exhaust shaft 49 as the supply shaft 48 rotates.

Two tooth portions 47A are arranged on the upper surface of the exhaust slide door 47 so as to extend in the left-right direction. The tooth portion 47A of the exhaust slide door 47 is formed so as to mesh with the gear 49A of the exhaust shaft 49.

Therefore, the power generated by the drive motor 50 is transmitted through the supply shaft 48 to rotate the exhaust shaft 49. As a result, the exhaust slide door 47 slides between the warm air exhaust opening 37 and the cold air exhaust opening 42. That is, in the seat air conditioner 1, the exhaust slide door 47 can slide to a position in the left-right direction by controlling the operation of the drive motor 50 by the air conditioning control unit 100.

According to the seat air conditioner 1, the power of the drive motor 50 can be transmitted to the supply slide door 46 and the exhaust slide door 47 via the supply shaft 48 and the exhaust shaft 49. As a result, the seat air conditioner 1 can interlock the slide movement of the supply slide door 46 and the slide movement of the exhaust slide door 47.

As shown in FIGS. 5 to 10, when the exhaust slide door 47 moves so that the opening area of the cold air exhaust opening 42 increases, the supply slide door 46 moves to increase the opening area of the warm air supply opening 36.

In this case, when the air volume ratio of the cold air CA in the air flowing into the exhaust space 57A increases, the air volume ratio of the warm air WA in the air flowing into the supply space 56A increases. The seat air conditioner 1 can supply air to the target space at a temperature lower than that in the heating mode and higher than that in the cooling mode, so as to realize an air mix mode closer to a heating operation.

When the exhaust slide door 47 moves so that the opening area of the warm air exhaust opening 37 increases, the supply slide door 46 moves so that the opening area of the cold air supply opening 41 increases.

In this case, when the air volume ratio of the warm air WA in the air flowing into the exhaust space 57A increases, the air volume ratio of the cold air CA in the air flowing into the supply space 56A increases. The seat air conditioner 1 can supply air to the target space at a temperature lower than that of the heating mode and higher than that of the cooling mode, so as to realize an air mix mode closer to a cooling operation.

According to the seat air conditioner 1 of the embodiment, air whose temperature is adjusted appropriately can be supplied to the target space of the rear seat SB using the warm air WA heated by the condenser 22 of the refrigeration cycle device 20 and the cold air CA cooled by the evaporator 24.

According to the seat air conditioner 1, it is possible to realize the cooling mode, the heating mode, and the air mix mode by controlling the operations of the warm air switching unit 35 and the cold air switching unit 40. The cooling mode is set for supplying the cold air CA to the target space. The heating mode is set for supplying the warm air WA to the target space. The air mix mode is set for supplying air to the target space, in which the temperature of the air is controlled by mixing the cold air CA and the warm air WA.

Next, the operation of the seat air conditioner 1 in the cooling mode will be described with reference to FIGS. 5 to 7. In the cooling mode, the air conditioning control unit 100 closes the warm air supply opening 36 with the supply slide door 46 and closes the cold air exhaust opening 42 with the exhaust slide door 47, by controlling the warm air switching unit 35 and the cold air switching unit 40.

When the first blower 30 is operated in this state, as shown in FIG. 6, the air flows in order of the cold air vent 13, the evaporator 24, the cold air passage 18, the cold air supply opening 41, the supply space 56A, the first blower 30, and the supply port 14. As a result, the cold air CA cooled by the cold heat of the evaporator 24 is supplied from the supply port 14 to the target space of the rear seat SB.

In the cooling mode, the warm air supply opening 36 is closed by the supply slide door 46. Therefore, in this case, the first blower 30 does not produce a flow of air flowing in order of the warm air vent 12, the condenser 22, the warm air passage 17, and the warm air supply opening 36.

In the cooling mode of the seat air conditioner 1, the cold air CA is generated by cooling the air blown by the first blower 30 by heat exchange with the low-pressure refrigerant in the evaporator 24. That is, the heat absorption amount of the refrigerant in the evaporator 24 of the refrigeration cycle device 20 is greatly affected by the amount of air blown by the first blower 30. In other words, the seat air conditioner 1 can adjust the heat absorption amount of the refrigerant in the evaporator 24 by adjusting the air flow rate of the first blower 30 in the cooling mode.

When the second blower 31 is operated in the cooling mode, as shown in FIG. 7, the air flows in order of the warm air vent 12, the condenser 22, the warm air passage 17, the warm air exhaust opening 37, the exhaust space 57A, the second blower 31, and the exhaust port 16. As a result, the warm air WA heated by the warm heat of the condenser 22 is blown from the exhaust port 16 to outside of the target space.

In the cooling mode, the cold air exhaust opening 42 is closed by the exhaust slide door 47. Therefore, in this case, the second blower 31 does not cause a flow of air flowing in order of the cold air vent 13, the evaporator 24, the cold air passage 18, and the cold air exhaust opening 42.

In the cooling mode of the seat air conditioner 1, the warm air WA is generated by heating the air blown by the second blower 31 with the heat of the high-pressure refrigerant in the condenser 22. That is, the heat radiation amount of the refrigerant in the condenser 22 of the refrigeration cycle device 20 is greatly affected by the air blowing amount of the second blower 31. In other words, the seat air conditioner 1 can adjust the heat radiation amount of the refrigerant in the condenser 22 by adjusting the air flow amount of the second blower 31 in the cooling mode.

As described above, in the seat air conditioner 1, the cold air CA cooled by the evaporator 24 is supplied from the supply port 14 to the target space of the rear seat SB by the first blower 30, and the warm air WA heated by the condenser 22 can be exhausted from the exhaust port 16 by the second blower 31. That is, the seat air conditioner 1 can realize a cooling mode in which the cold air CA is supplied to the target space of the rear seat SB.

According to the seat air conditioner 1, the heat absorption amount of the refrigerant in the evaporator 24 can be adjusted by adjusting the amount of air blown by the first blower 30 in the cooling mode. Further, the heat radiation amount of the refrigerant in the condenser 22 can be controlled by adjusting the amount of air blown by the second blower 31.

Accordingly, the seat air conditioner 1 can appropriately adjust the heat radiation amount of the refrigerant in the condenser 22 and the heat absorption amount of the refrigerant in the evaporator 24 in the cooling mode. Thus, the refrigeration cycle device 20 can be easily balanced and stably operated.

The first blower 30 in the cooling mode functions as a blower for supplying the conditioned air to the target space, and at the same time, functions as a blower for sending the cold air CA. That is, the first blower 30 sucks air through the evaporator 24 as at least one of the condenser 22 and the evaporator 24.

The second blower 31 in this case is an exhaust blower for blowing air to the outside of the target space, and at the same time functions as a warm air blower for blowing the warm air WA. That is, the second blower 31 sucks air through the condenser 22 as at least the other of the condenser 22 and the evaporator 24.

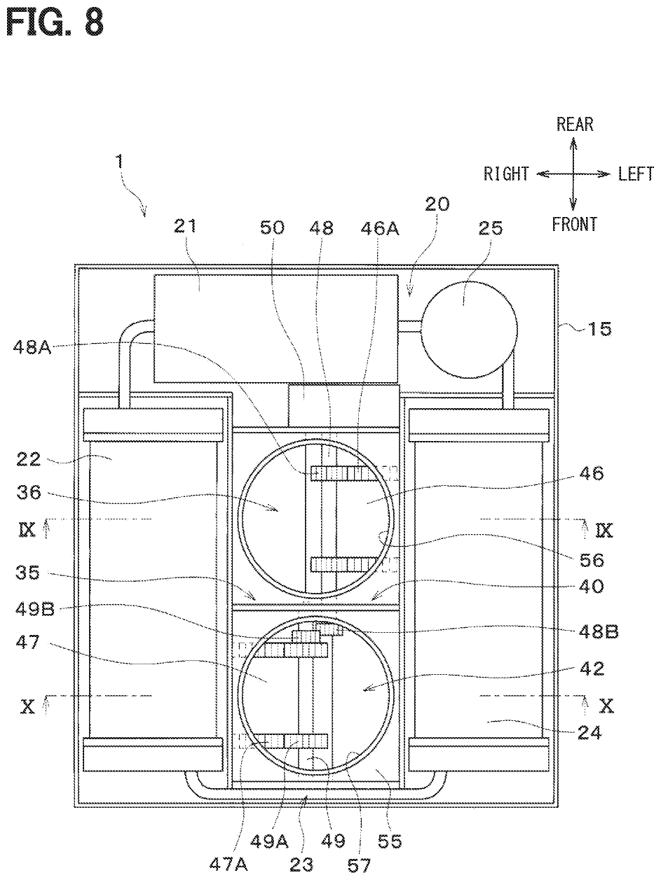

Next, the operation of the seat air conditioner 1 in the heating mode will be described with reference to FIGS. 8 to 10. In the heating mode, the air conditioning control unit 100 closes the cold air supply opening 41 with the supply slide door 46, and closes the warm air exhaust opening 37 with the exhaust slide door 47 by controlling the warm air switching unit 35 and the cold air switching unit 40.

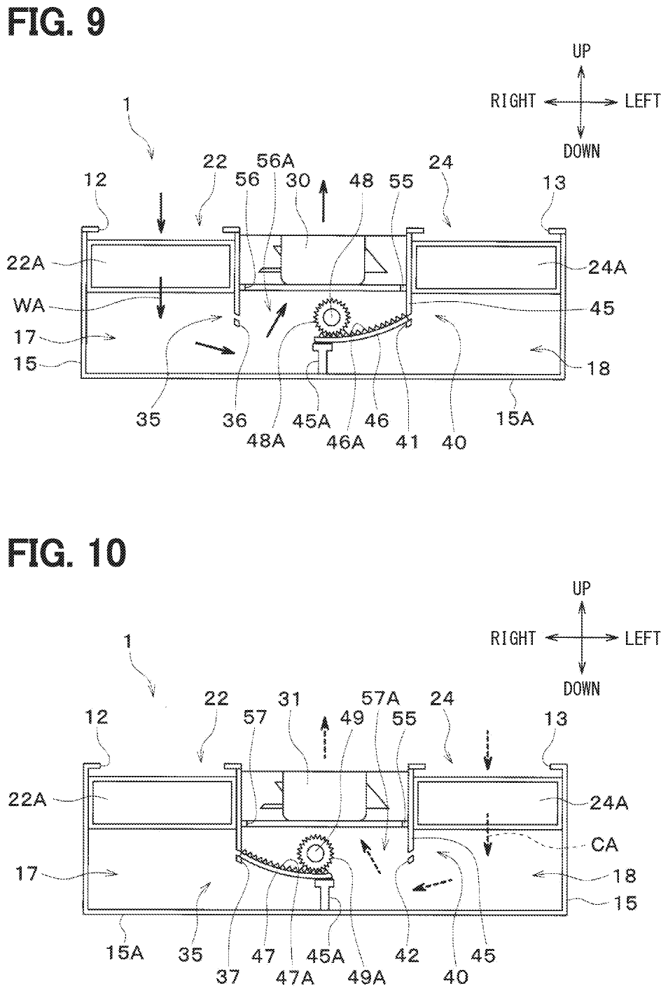

As shown in FIG. 9, when the first blower 30 is operated in the heating mode, the air flows in order of the warm air vent 12, the condenser 22, the warm air passage 17, the warm air supply opening 36, the supply space 56A, the first blower 30, and the supply port 14. As a result, the warm air WA heated by the warm heat of the condenser 22 is supplied from the supply port 14 to the target space of the rear seat SB.

In the heating mode, the cold air supply opening 41 is closed by the supply slide door 46. Therefore, the first blower 30 does not generate a flow of air flowing in order of the cold air vent 13, the evaporator 24, the cold air passage 18, and the cold air supply opening 41.

Therefore, in the heating mode of the seat air conditioner 1, the warm air WA is generated by heating the air blown by the first blower 30 with the heat of the high-pressure refrigerant in the condenser 22. That is, the heat radiation amount of the refrigerant in the condenser 22 of the refrigeration cycle device 20 is greatly influenced by the air amount blown by the first blower 30. In other words, the seat air conditioner 1 can adjust the heat radiation amount of the refrigerant in the condenser 22 by adjusting the air amount blown by the first blower 30 in the heating mode.

When the second blower 31 is operated in the heating mode, as shown in FIG. 10, the air flows in order of the cold air vent 13, the evaporator 24, the cold air passage 18, the cold air exhaust opening 42, the exhaust space 57A, the second blower 31, and the exhaust port 16. As a result, the cold air CA cooled by the cold heat of the evaporator 24 is blown from the exhaust port 16 to the outside of the target space.

In the heating mode, the warm air exhaust opening 37 is closed by the exhaust slide door 47. Therefore, the second blower 31 does not cause a flow of air flowing in order of the warm air vent 12, the condenser 22, the warm air passage 17, and the warm air exhaust opening 37.

Therefore, in the heating mode of the seat air conditioner 1, the cold air CA is generated by absorbing heat in the low-pressure refrigerant in the evaporator 24 with the air blown by the second blower 31. That is, the heat absorption amount of the refrigerant in the evaporator 24 of the refrigeration cycle device 20 is greatly affected by the amount of air blown by the second blower 31. In other words, the seat air conditioner 1 can adjust the heat absorption amount of the refrigerant in the evaporator 24 by adjusting the amount of air blown by the second blower 31 in the heating mode.

As described above, the seat air conditioner 1 supplies the warm air WA heated by the condenser 22 to the target space from the supply port 14 by the first blower 30 and sends the cold air CA cooled by the evaporator 24 by the second blower 31 from the exhaust port 16. That is, the seat air conditioner 1 can realize the heating mode in which the warm air WA is supplied to the seat, which is the target space to be air-conditioned.

According to the seat air conditioner 1, the heat radiation amount of the refrigerant in the condenser 22 can be adjusted by adjusting the air flow rate of the first blower 30 in the heating mode. Further, the amount of heat absorbed by the refrigerant in the evaporator 24 can be controlled by adjusting the amount of air blown by the second blower 31.

Accordingly, the seat air conditioner 1 can appropriately adjust the heat radiation amount of the refrigerant in the condenser 22 and the heat absorption amount of the refrigerant in the evaporator 24 in the heating mode. Thus, the refrigeration cycle device 20 can be easily balanced and stably operated.

The first blower 30 in the heating mode functions as a blower for supplying conditioned air to the target space, and at the same time functions as a blower for sending the warm air WA. That is, the first blower 30 sucks air through the condenser 22 as at least one of the condenser 22 and the evaporator 24.

The second blower 31 in this case is an exhaust blower for blowing air to the outside of the target space, and at the same time, functions as a blower for blowing the cold air CA. That is, the second blower 31 sucks air through the evaporator 24 as at least the other of the condenser 22 and the evaporator 24.

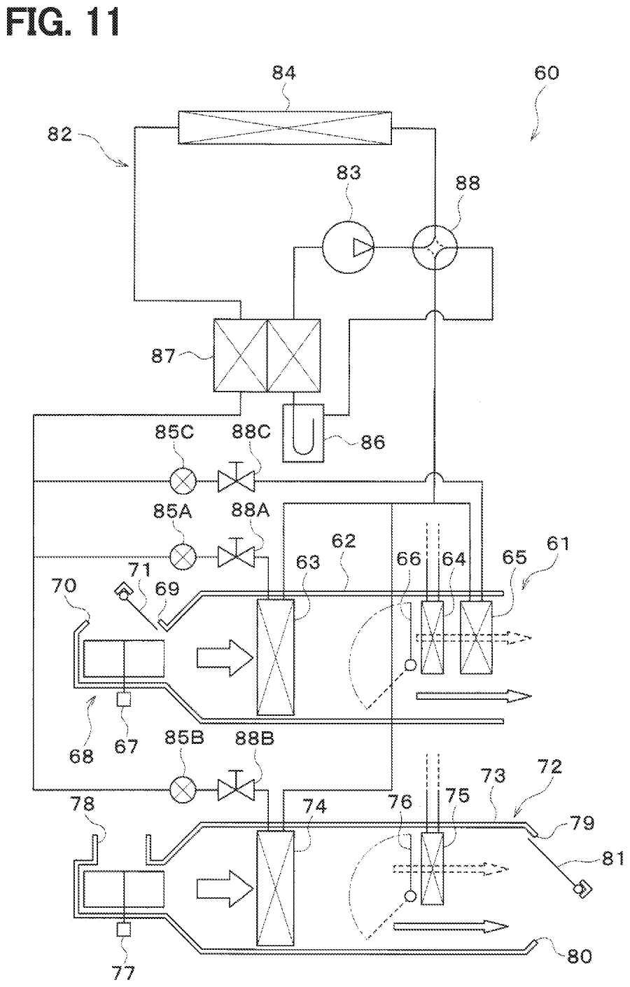

Next, a specific configuration of the indoor air conditioner 60 of the vehicle cabin air conditioning system AS will be described with reference to FIG. 11. As described above, the indoor air conditioner 60 conditions air for the entire cabin C of the hybrid vehicle, and has the front seat air conditioning unit 61 and the rear seat air conditioning unit 72. The indoor air conditioner 60 corresponds to a thermal load reducing unit.

The front seat air conditioning unit 61 has a front seat casing 62 arranged inside the instrument panel on the front side of the cabin C. The front seat casing 62 forms an air passage for supplying the conditioned air A from the front side of the cabin C in the front seat air conditioning unit 61. A first interior heat exchanger 63, a front seat heater core 64, and a second interior heat exchanger 65 are housed inside the front seat casing 62.

The low-pressure refrigerant that circulates in the cabin side refrigeration cycle 82 and air to be blown into the cabin C exchange heat in the first interior heat exchanger 63. The front seat heater core 64 is a radiator for heating the air by the heat of the high-temperature heat medium. The high-pressure refrigerant circulating in the cabin side refrigeration cycle 82 and air to be blown into the cabin C exchange heat in the second interior heat exchanger 65.

As the high-temperature heat medium in the front seat heater core 64, it is possible to use cooling water that recovers heat exhausted from a component such as an engine of the hybrid vehicle, high-pressure refrigerant in the refrigeration cycle, or the like.

As shown in FIG. 11, the first interior heat exchanger 63, the front seat heater core 64, and the second interior heat exchanger 65 are arranged in this order from the upstream side in the air flow inside the front seat casing 62.

A front seat air mix door 66 is rotatably arranged at the upstream side of the front seat heater core 64 in the air flow. The front seat air mix door 66 controls the amount of warm air heated by passing through the front seat heater core 64 and the second interior heat exchanger 65 to flow into the cabin C and the amount of cold air that bypasses the front seat heater core 64 and the second interior heat exchanger 65 to flow into the cabin C.

Therefore, the temperature of the conditioned air A blown from the front seat air conditioning unit 61 into the cabin C is controlled by adjusting the opening degree of the front seat air mix door 66 (that is, the air flow ratio between the warm air amount and the cold air amount).

A front seat blower 67 and an inside/outside air switching box 68 are arranged in the front seat casing 62. The inside/outside air switching box 68 switchingly introduces air (inside air) inside the cabin C and/or air (outside air) outside the cabin C into the air passage inside the front seat casing 62.

The inside/outside air switching box 68 has an inside air inlet 69 communicating with the inside of the cabin C, an outside air inlet 70 communicating with outside of the cabin C, and a switching door 71. The switching door 71 is rotatably arranged inside the inside/outside air switching box 68, and is driven by a servo motor (not shown).

The inside/outside air switching box 68 drives the switching door 71 to set an inside air mode to introduce the inside air IA (air inside the cabin) through the inside air inlet 69, and an outside air mode to introduce the outside air OA (air outside the cabin) through the outside air inlet 70. That is, the inside/outside air switching box 68 can adjust the inside air amount and the outside air amount with respect to the air supplied to the cabin C through the front seat casing 62.

The front seat blower 67 is arranged downstream of the inside/outside air switching box 68 in the air flow. The front seat blower 67 sends air into the cabin C by driving a centrifugal multi-blade fan by an electric motor. The front seat blower 67 can adjust the amount of air blown from the front seat air conditioning unit 61 into the cabin C by performing drive control of the electric motor by the air conditioning control unit 100.

As shown in FIG. 1, the rear seat air conditioning unit 72 has a rear seat casing 73 arranged in the rearmost part of the cabin C (for example, a trunk room or a luggage space). The rear seat casing 73 forms an air passage for supplying the conditioned air A from the rear side of the cabin C in the rear seat air conditioning unit 72. A rear seat interior heat exchanger 74 and a rear seat heater core 75 and the like are housed in the rear seat casing 73.

Heat is exchanged between the refrigerant circulating in the cabin side refrigeration cycle 82 and air supplied from the rear seat air conditioning unit 72 into the cabin C in the rear seat interior heat exchanger 74. The rear seat heater core 75 is disposed on the downstream side of the rear seat casing 73 in the air flow, and is a radiator that radiates heat of the high-temperature heat medium in the indoor air conditioner 60 to the air supplied from the rear seat air conditioning unit 72 into the cabin C.

The high-temperature heat medium in the rear seat heater core 75, as in the front seat heater core 64, may be cooling water that collects heat generated in a component such as an engine of a hybrid vehicle, or high-pressure refrigerant in a refrigeration cycle. The high-temperature heat medium may be the same as the high-temperature heat medium in the front seat heater core 64, or may be different from that in the front seat heater core 64.

The rear seat air mix door 76 is rotatably arranged upstream of the rear seat heater core 75 in the air flow, inside the rear seat casing 73. The rear seat air mix door 76 adjusts the amount of warm air heated while passing through the rear seat heater core 75 toward the cabin C, and the amount of cold air that bypasses the rear seat heater core 75 to flow into the cabin C.

A rear seat blower 77 and a rear seat suction port 78 are arranged in the rear seat air conditioning unit 72. The rear seat blower 77 is arranged inside the rear seat casing 73, and sends air by driving a centrifugal multi-blade fan by an electric motor. The rear seat blower 77 can adjust the amount of air blown from the rear seat air conditioning unit 72 into the cabin C by controlling the drive of the electric motor by the air conditioning control unit 100.

The rear seat suction port 78 is arranged upstream of the rear seat blower 77 in the air flow inside the rear seat casing 73. The rear seat suction port 78 communicates the inside of the rear seat casing 73 with the inside of the cabin C. Therefore, the rear seat air conditioning unit 72 can suck air outside the rear seat casing 73 from the rear seat suction port 78 while the rear seat blower 77 is operated.

A first outlet 79, a second outlet 80, and an air volume adjusting door 81 are arranged at the downstream side in the air flow inside the rear seat casing 73. The first outlet 79 and the second outlet 80 communicate the inside of the rear seat casing 73 with the inside of the cabin C, and are opening through which the conditioned air A is supplied from the rear seat air conditioning unit 72 into the cabin C.

The first outlet 79 and the second outlet 80 are arranged at different positions in the rear seat casing 73. For example, the first outlet 79 is arranged on the front side of the rear seat casing 73, and the second outlet 80 is arranged on the upper surface of the rear seat casing 73.

As shown in FIG. 1, in the vehicle cabin air conditioning system AS according to the present embodiment, the end of the supply duct 90 is connected to the first outlet 79. Therefore, the rear seat air conditioning unit 72, along with the operation of the rear seat blower 77, supplies the conditioned air A whose temperature is adjusted in the vehicle cabin side refrigeration cycle 82 via the first outlet 79 and the supply duct 90 to the seat air conditioner 1.

The air volume adjusting door 81 is rotatably arranged upstream of the first outlet 79 and the second outlet 80 in the air flow, and is able to close the first outlet 79 or the second outlet 80. The air volume adjusting door 81 is driven by a servo motor (not shown) and can adjust the opening area of the first outlet 79 and the opening area of the second outlet 80.

That is, the air volume adjusting door 81 can adjust the flow rate of the conditioned air A blown out from the rear seat air conditioning unit 72 through the first outlet 79 and the flow rate of the conditioned air A blown out from the rear seat air conditioning unit 72 through the second outlet 80. Further, the air volume adjusting door 81 can be switched so as to blow out air from either the first outlet 79 or the second outlet 80.

In the vehicle cabin air conditioning system AS, the rear seat air conditioning unit 72 of the indoor air conditioner 60 can realize an operation mode to reduce the thermal load of the refrigeration cycle device 20 in the air conditioning operation of the seat air conditioner 1. Further, the rear seat air conditioning unit 72 can switchingly perform an operation mode in which air inside of the cabin C is entirely conditioned, or an operation mode in which the thermal load is reduced in the air conditioning operation of the seat air conditioner 1 while air inside of the cabin C is entirely conditioned.

Next, a specific configuration of the cabin side refrigeration cycle 82 will be described with reference to FIG. 11 for the indoor air conditioner 60 to adjust the temperature.

The cabin side refrigeration cycle 82 is a so-called vapor compression type refrigeration cycle, and is arranged over the front seat air conditioning unit 61 and the rear seat air conditioning unit 72 that form the indoor air conditioner 60. The cabin side refrigeration cycle 82 corresponds to a temperature control unit.

As shown in FIG. 11, the cabin side refrigeration cycle 82 has the first interior heat exchanger 63, the second interior heat exchanger 65, and the rear seat interior heat exchanger 74. The cabin side refrigeration cycle 82 further includes a compressor 83, an outdoor heat exchanger 84, a first to third pressure reducing portions 85A to 85C, a gas-liquid separator 86, an internal heat exchanger 87, a four-way valve 88 and a first to third solenoid valves 88A to 88C.

HFC-based refrigerant (specifically, R134a) is adopted as the refrigerant circulating in the cabin side refrigerating cycle 82, similarly to the refrigerating cycle device 20, such that vapor compression subcritical refrigeration cycle is provided in which the pressure of high-pressure side refrigerant does not exceed the critical pressure of the refrigerant. HFO refrigerant (e.g., R1234yf) or a natural refrigerant (e.g., R744) may be employed as the refrigerant. Refrigerant oil for lubricating the compressor 83 is mixed into the refrigerant and a part of the refrigerant oil circulates through the cycle together with the refrigerant.

The compressor 83 draws in, compresses, and discharges the refrigerant circulating in the cabin side refrigeration cycle 82. The refrigerant circulates in the cycle by the operation of the compressor 83 in the cabin side refrigeration cycle 82. The outdoor heat exchanger 84 exchanges heat between outdoor air and the refrigerant circulating in the cabin side refrigeration cycle 82. The outdoor heat exchanger 84 functions as a radiator or a heat absorber by switching the refrigerant circuit in the cabin side refrigeration cycle 82.

As shown in FIG. 11, the first interior heat exchanger 63, the second interior heat exchanger 65, and the rear seat interior heat exchanger 74 are connected in parallel with each other between the internal heat exchanger 87 and the four-way valve 88.

The first to third pressure reducing portions 85A to 85C depressurize and expand the high-pressure refrigerant in the cabin side refrigeration cycle 82 in an isenthalpic manner, and are configured by, for example, expansion valves. The first pressure reducing portion 85A is arranged in the refrigerant pipe connected to the first interior heat exchanger 63 to decompress the refrigerant flowing through the refrigerant pipe.

The second pressure reducing portion 85B is arranged in the refrigerant pipe connected to the rear seat interior heat exchanger 74 to decompress the refrigerant flowing through the refrigerant pipe. The third pressure reducing portion 85C is arranged in the refrigerant pipe connected to the second interior heat exchanger 65 to decompress the refrigerant flowing through the refrigerant pipe.

The gas-liquid separator 86 separates the refrigerant passing through the gas-liquid separator 86 into a gas-phase refrigerant and a liquid-phase refrigerant, and stores a surplus refrigerant in the cycle as a liquid-phase refrigerant. Since the gas-liquid separator 86 is arranged on the suction side of the compressor 83, the gas-phase refrigerant can be reliably supplied to the compressor 83.

In the internal heat exchanger 87, heat is exchanged between the low-pressure refrigerant drawn into the compressor 83 and the high-pressure refrigerant flowing through the cabin side refrigeration cycle 82. The internal heat exchanger 87 can reduce the enthalpy of the refrigerant flowing into the first pressure reducing portion 85A and the second pressure reducing portion 85B by heat exchange inside.

The four-way valve 88 constitutes a circuit switching unit for switching the refrigerant circuit in the cabin side refrigeration cycle 82. The four-way valve 88 has four refrigerant outlet/inlet ports, and the refrigerant pipe is connected to each of the ports.

Specifically, the refrigerant outlet/inlet ports of the four-way valve 88 are connected with s a discharge pipe of the compressor 83, a refrigerant pipe connected to the outdoor heat exchanger 84, a refrigerant pipe connected to the gas-liquid separator 86, and a refrigerant pipe connected in parallel with the first interior heat exchanger 63.

The four-way valve 88 can switch the refrigerant circuit of the cabin side refrigeration cycle 82 by switching the connection mode of the four refrigerant pipes, thereby switching the air conditioning modes such as cooling and heating in the indoor air conditioner 60. Specifically, the four-way valve 88 changes the refrigerant discharged from the compressor 83 to flow toward the outdoor heat exchanger 84 or to flow toward the second interior heat exchanger 65 and the rear seat interior heat exchanger 74 by switching.

As shown in FIG. 11, the first solenoid valve 88A is connected to the inlet/outlet port of the first pressure reducing portion 85A. The first solenoid valve 88A is an opening/closing valve that opens/closes the refrigerant passage in which the first pressure reducing portion 85A is arranged. The second solenoid valve 88B is connected to the inlet/outlet port of the second pressure reducing portion 85B. The second solenoid valve 88B opens/closes the refrigerant passage in which the second pressure reducing portion 85B is arranged.

The third solenoid valve 88C is connected to the inlet/outlet side of the third pressure reducing portion 85C. The third solenoid valve 88C opens/closes the refrigerant passage in which the third pressure reducing portion 85C is arranged. In the cabin side refrigeration cycle 82, the refrigerant circuit can be switched by controlling the opening/closing of the first solenoid valve 88A to the third pressure reducing portion 85C. That is, the first solenoid valve 88A to the third solenoid valve 88C form a circuit switching unit similarly to the four-way valve 88.

Next, the operation of the indoor air conditioner 60 in the cooling mode will be described. In this case, the air conditioning control unit 100 controls the first solenoid valve 88A and the second solenoid valve 88B to be in the open state, and controls the third solenoid valve 88C to be in the closed state. The four-way valve 88 is also controlled so that the refrigerant discharged from the compressor 83 flows into the outdoor heat exchanger 84.

As a result, when the indoor air conditioner 60 is in the cooling mode, the refrigerant in the cabin side refrigeration cycle 82 flows in order of the compressor 83, the four-way valve 88, the outdoor heat exchanger 84, and the internal heat exchanger 87. The refrigerant is branched into a refrigerant passage having the first pressure reducing portion 85A and a refrigerant passage having the second pressure reducing portion 85B.

In the refrigerant passage having the first pressure reducing portion 85A, the refrigerant flows in order of the first pressure reducing portion 85A, the first solenoid valve 88A, and the first interior heat exchanger 63. In the refrigerant passage having the second pressure reducing portion 85B, the refrigerant flows in order of the second pressure reducing portion 85B, the second solenoid valve 88B, and the rear seat interior heat exchanger 74.

The refrigerant flowing out from the first interior heat exchanger 63 merges with the refrigerant flowing out from the rear seat interior heat exchanger 74. The refrigerant flows in order of the four-way valve 88, the gas-liquid separator 86, and the internal heat exchanger 87, and is sucked into the compressor 83 again.

According to the cooling mode, air flowing through the front seat casing 62 can be cooled by the cold heat of the low-pressure refrigerant decompressed by the first pressure reducing portion 85A in the cabin side refrigeration cycle 82. Therefore, the front seat air conditioning unit 61 can supply the conditioned air A cooled in the cabin side refrigeration cycle 82 into the cabin C.

In the cabin side refrigeration cycle 82, the cold heat of the low-pressure refrigerant decompressed by the second pressure reducing portion 85B can cool the air flowing through the rear seat casing 73. Therefore, the rear seat air conditioning unit 72 can supply the conditioned air A cooled in the cabin side refrigeration cycle 82 into the cabin C.

In the cabin side refrigeration cycle 82 in the cooling mode, the outdoor heat exchanger 84 functions as a radiator that radiates the warm heat of the high-pressure refrigerant of the cabin side refrigeration cycle 82 to outside air outside the cabin C.

The dehumidifying and heating mode of the front seat air conditioning unit 61 and the dehumidifying and heating mode of the rear seat air conditioning unit 72 can be realized individually by allowing the high-temperature heat medium to flow into the front seat heater core 64 and the rear seat heater core 75 in this refrigerant circuit state.

In the dehumidifying and heating mode of the front seat air conditioning unit 61, the high-temperature heat medium is supplied to the front seat heater core 64 so that the air cooled by the first interior heat exchanger 63 can be heated by the warm heat of the front seat heater core 64, to supply the dehumidified and heated conditioned air A. At this time, the temperature of the dehumidified and heated conditioned air A can be adjusted to a desired temperature by controlling the operation of the front seat air mix door 66.

In the dehumidifying and heating mode of the rear seat air conditioning unit 72, the high-temperature heat medium is supplied to the rear seat heater core 75, so that the air cooled by the rear seat interior heat exchanger 74 is heated by warm heat of the rear seat heater core 75. Thus, it is possible to supply the dehumidified and heated conditioned air A. In this case, the temperature of the dehumidified and heated conditioned air A can be adjusted to a desired temperature by controlling the operation of the rear seat air mix door 76.

Next, the operation of the indoor air conditioner 60 in the heating mode will be described. In the heating mode, the air conditioning control unit 100 controls the second solenoid valve 88B and the third solenoid valve 88C to be in the open state and the first solenoid valve 88A to be in the closed state. The four-way valve 88 is controlled so that the refrigerant discharged from the compressor 83 flows into the second interior heat exchanger 65 and the rear seat interior heat exchanger 74.

As a result, when the indoor air conditioner 60 is in the cooling mode, the refrigerant in the cabin side refrigeration cycle 82 flows in order of the compressor 83 and the four-way valve 88, and is branched into the refrigerant passage having the rear seat interior heat exchanger 74 and the refrigerant passage having the second interior heat exchanger 65.

In the refrigerant passage having the rear seat interior heat exchanger 74, the refrigerant flows in order of the rear seat interior heat exchanger 74, the second solenoid valve 88B, and the second pressure reducing portion 85B. In the refrigerant passage having the second interior heat exchanger 65, the refrigerant flows in order of the second interior heat exchanger 65, the third solenoid valve 88C, and the third pressure reducing portion 85C.

The refrigerant flowing out from the second pressure reducing portion 85B merges with the refrigerant flowing out from the third pressure reducing portion 85C. The refrigerant flows in order of the internal heat exchanger 87, the outdoor heat exchanger 84, the four-way valve 88, the gas-liquid separator 86, the internal heat exchanger 87, and is again sucked into the compressor 83.

According to the heating mode, in the cabin side refrigeration cycle 82, the warm heat of the high-pressure refrigerant flowing out of the compressor 83 is dissipated in the second interior heat exchanger 65, so that the air flowing through the front seat casing 62 can be heated. Therefore, the front seat air conditioning unit 61 can supply the conditioned air A heated in the cabin side refrigeration cycle 82 into the cabin C.

In the cabin side refrigeration cycle 82, the warm heat of the high-pressure refrigerant flowing out from the compressor 83 is dissipated by the rear seat interior heat exchanger 74, so that the air flowing through the rear seat casing 73 can be heated. Therefore, the rear seat air conditioning unit 72 can supply the conditioned air A heated in the cabin side refrigeration cycle 82 into the cabin C.

In the cabin side refrigeration cycle 82 in the heating mode, the outdoor heat exchanger 84 functions as a heat absorber, and absorbs the heat of the outdoor air into the low-pressure refrigerant of the cabin side refrigeration cycle 82.

Next, the supply duct 90 of the vehicle cabin air conditioning system AS according to the present embodiment will be described in detail. As shown in FIG. 1, the supply duct 90 is disposed between the seat air conditioner 1 and the rear seat air conditioning unit 72 of the indoor air conditioner 60.

One end of the supply duct 90 in the present embodiment is connected to the first outlet 79 of the seat air conditioner 1. Therefore, the conditioned air A whose temperature has been adjusted by the rear seat air conditioning unit 72 of the indoor air conditioner 60 flows into the supply duct 90 from the first outlet 79.

The supply air amount controller 91 is arranged in the flow path of the supply duct 90. The supply air amount controller 91 has one inflow port and two outflow ports, and the first outlet 79 is connected to the one inflow port via the supply duct 90.

The supply duct 90 extending to the warm air vent 12 is connected to one of the outflow ports of the supply air amount controller 91, and the supply duct 90 extending to the cold air vent 13 is connected to the other of the outflow ports of the supply air amount controller 91.

As described above, the supply air amount controller 91 can control the balance between the flow rate of the conditioned air A supplied from the first outlet 79 to the warm air vent 12 and the flow rate of the conditioned air A supplied from the first outlet 79 to the cold air vent 13.

One of the other end portions of the supply duct 90 is attached to the warm air vent 12 of the seat air conditioner 1, and the other of the other end portions of the supply duct 90 is attached to the cold air vent 13 of the seat air conditioner 1.

Therefore, the conditioned air A flowing through the supply duct 90 is guided to the inside of the housing 10 of the seat air conditioner 1 from the warm air vent 12 and the cold air vent 13. That is, the supply duct 90 functions as a supply flow path.

The other end portion of the supply duct 90 is arranged around the warm air vent 12 and the cold air vent 13, and is fixed in a state where a space is provided between the warm air vent 12 and the cold air vent 13. Therefore, the warm air vent 12 and the cold air vent 13 can suck not only the conditioned air A from the supply duct 90 but also air in the cabin C.

The other end portion of the supply duct 90 may be fixed in other way relative to the warm air vent 12 and the cold air vent 13 while the conditioned air A can flow into the warm air vent 12 and the cold air vent 13 of the seat air conditioner 1. For example, the other end portion of the supply duct 90 may be directly connected and fixed to the warm air vent 12 and the cold air vent 13.

The supply duct 90 is configured so that its length can be expanded and contracted. For example, the supply duct 90 is made of a flexible duct in a bellows shape (so-called bellows duct). Therefore, when the rear seat SB is slid in the front-rear direction in the cabin C, the supply duct 90 expands or contracts.

As a result, the position of one end of the supply duct 90 can be maintained with respect to the first outlet 79, and the position of the other end of the supply duct 90 can be maintained with respect to the warm air vent 12 and the cold air vent 13. Thus, the conditioned air A can be stably guided from the first outlet 79 to the warm air vent 12 and/or the cold air vent 13.

According to the vehicle cabin air conditioning system AS, the conditioned air A from the first outlet 79 of the rear seat air conditioning unit 72 can be guided to the warm air vent 12 and the cold air vent 13 of the seat air conditioner 1 via the supply duct 90. Therefore, the vehicle cabin air conditioning system AS can reduce the thermal load in the air conditioning operation of the seat air conditioner 1.

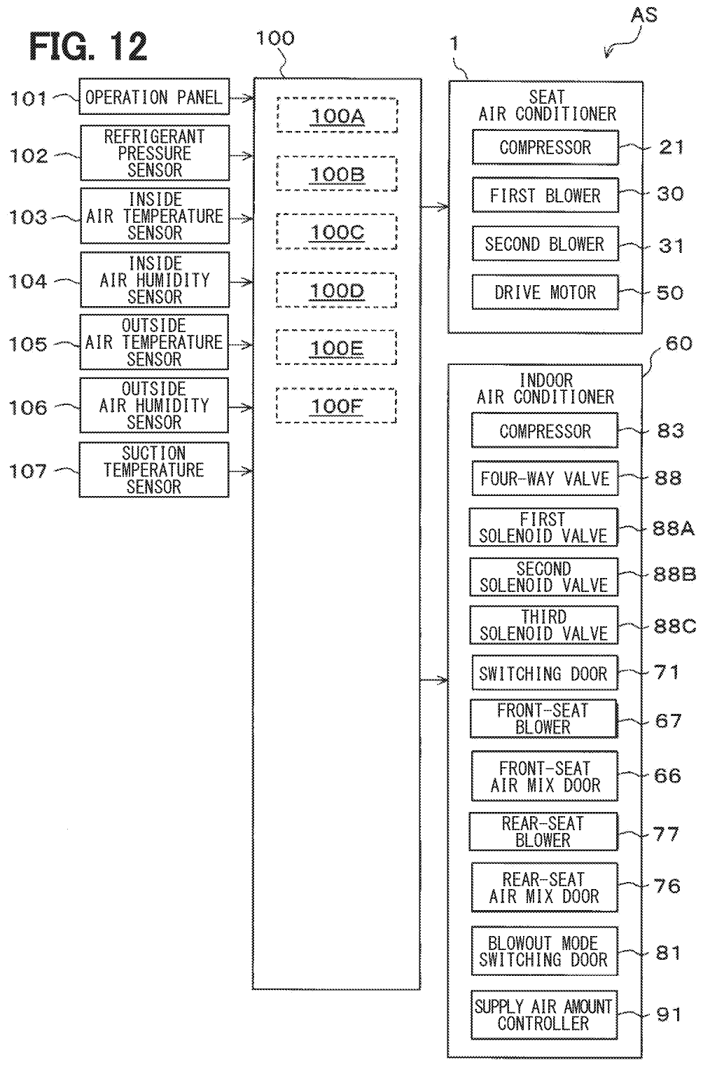

Next, the control system of the vehicle cabin air conditioning system AS will be described with reference to FIG. 12. As shown in FIG. 12, the vehicle cabin air conditioning system AS includes the air conditioning control unit 100 for controlling each component of the vehicle cabin air conditioning system AS.

The air conditioning control unit 100 includes a well-known microcomputer including a CPU, a ROM, a RAM, and the like, and peripheral circuits of the microcomputer. Then, the air conditioning control unit 100 performs various arithmetic processes based on the control program stored in the ROM to control the operation of each component.

The seat air conditioner 1 and the indoor air conditioner 60 are connected on the output side of the air conditioning control unit 100, as control target devices in the vehicle cabin air conditioning system AS. More specifically, the compressor 21, the first blower 30, the second blower 31, and the drive motor 50 are connected to the output side of the air conditioning control unit 100 as components of the seat air conditioner 1.

Therefore, the air conditioning control unit 100 can control the air conditioning operation of the seat air conditioner 1, such as the refrigerant discharge performance of the compressor 21 (for example, the refrigerant pressure), the blowing performance of the first blower 30 (for example, the blowing amount), or the blowing performance of the second blower 31 according to the situation.

The air conditioning control unit 100 controls the operation of the drive motor 50 in the seat air conditioner 1 to adjust the air volume balance of the cold air CA and the warm air WA in the warm air switching unit 35 and the cold air switching unit 40. That is, the air conditioning control unit 100 can change the operation mode of the seat air conditioner 1 to one of the cooling mode, the heating mode, and the air mix mode.

As shown in FIG. 12, the front seat air mix door 66, the front seat blower 67, the switching door 71, the rear seat air mix door 76, the rear seat blower 77, the air volume adjusting door 81, the compressor 83, the four-way valve 88, the first solenoid valve 88A, the second solenoid valve 88B, the third solenoid valve 88C and the supply air amount controller 91 are connected on the output side of the air conditioning control unit 100 as components of the indoor air conditioner 60.

Therefore, the air conditioning control unit 100 can control the air conditioning operation in the indoor air conditioner 60. Specifically, the air conditioning control unit 100 can realize the air conditioning by the front seat air conditioning unit 61 and the air conditioning operation by the rear seat air conditioning unit 72.

The supply air amount controller 91 has a door member for adjusting on the flow path, and the door member is operated by a servo motor. Therefore, the air conditioning control unit 100 controls the operation of the supply air amount controller 91 so as to adjust the balance of the volume of the conditioned air A supplied to the warm air vent 12 of the seat air conditioner 1 and the volume of the conditioned air A supplied to the cold air vent 13.

The supply air amount controller 91 can block the flow of air to one of the warm air vent 12 or the cold air vent 13 so as to supply the conditioned air A to the other of the warm air vent 12 or the cold air vent 13 via the supply duct 90.

The operation panel 101 and plural air conditioning sensors are connected to the input side of the air conditioning control unit 100. The operation panel 101 is used for various operations by the passenger P in order to control the operation of the vehicle cabin air conditioning system AS. For example, the operation panel 101 is used to instruct the air conditioning mode of the seat air conditioner 1, and the air conditioning mode of the front seat air conditioning unit 61 and the rear seat air conditioning unit 72.

The air conditioning sensors connected to the air conditioning control unit 100 include a refrigerant pressure sensor 102, an inside air temperature sensor 103, an inside air humidity sensor 104, an outside air temperature sensor 105, an outside air humidity sensor 106, and a suction temperature sensor 107.

The refrigerant pressure sensor 102 is a detector for detecting the pressure of the high-pressure refrigerant in the cabin side refrigeration cycle 82. The inside air temperature sensor 103 is a detector for detecting the temperature of the inside air inside the cabin C. The inside air humidity sensor 104 is a detector for detecting the humidity of the inside air of the cabin C.

The outside air temperature sensor 105 is a detector for detecting the temperature of outside air outside the cabin C. The outside air humidity sensor 106 is a detector for detecting the humidity of outside air outside the cabin C.

The suction temperature sensor 107 is a detector that detects the temperature of the conditioned air A sucked from the warm air vent 12 or/and the cold air vent 13 of the seat air conditioner 1. In the present embodiment, the suction temperature sensor 107 is arranged at an opening edge of the warm air vent 12 and the cold air vent 13 in the seat air conditioner 1.

The air conditioning control unit 100 integrally has a control unit that controls various control devices connected to the output side thereof. A configuration (hardware and software) that controls the operation of each control device corresponds to a control unit that controls the operation of each control device.

For example, a portion of the air conditioning control unit 100 that controls the operation of the seat air conditioner 1 constitutes a seat air conditioning control unit 100A. A portion of the air conditioning control unit 100 that controls the operation of the front seat air conditioning unit 61 of the indoor air conditioner 60 constitutes a front seat air conditioning control unit 100B.

A portion of the air conditioning control unit 100 that controls the operation of the rear seat air conditioning unit 72 of the indoor air conditioner 60 constitutes a rear seat air conditioning control unit 100C. A portion of the air conditioning control unit 100 that specifies the suction load by using the detection result of the suction temperature sensor 107 corresponds to a suction load determination unit 100D. The suction load means an air conditioning thermal load of the refrigeration cycle device 20, regarding the conditioned air A sucked from the warm air vent 12 and the cold air vent 13 of the seat air conditioner 1.

A portion of the air conditioning control unit 100 that determines whether or not a predetermined load condition is satisfied using the suction load and a thermal load of the air in the cabin C, at an initial stage of the air conditioning operation of the seat air conditioner 1, corresponds to a condition determination unit 100E. The thermal load of the air in the cabin C means an air conditioning thermal load of the refrigeration cycle device 20 when the air in the cabin C is targeted.

A portion of the air conditioning control unit 100 that executes a circulation operation of circulating the air in the cabin C by the operation of the seat air conditioner 1 corresponds to a circulation operation control unit 100F. Details of the circulation operation will be described later.

The vehicle cabin air conditioning system AS is configured as shown in FIG. 12 to realize an individual air conditioning for the target space of the rear seat SB by the seat air conditioner 1, and at the same time, to realize air conditioning for the entire cabin C by the indoor air conditioner 60.

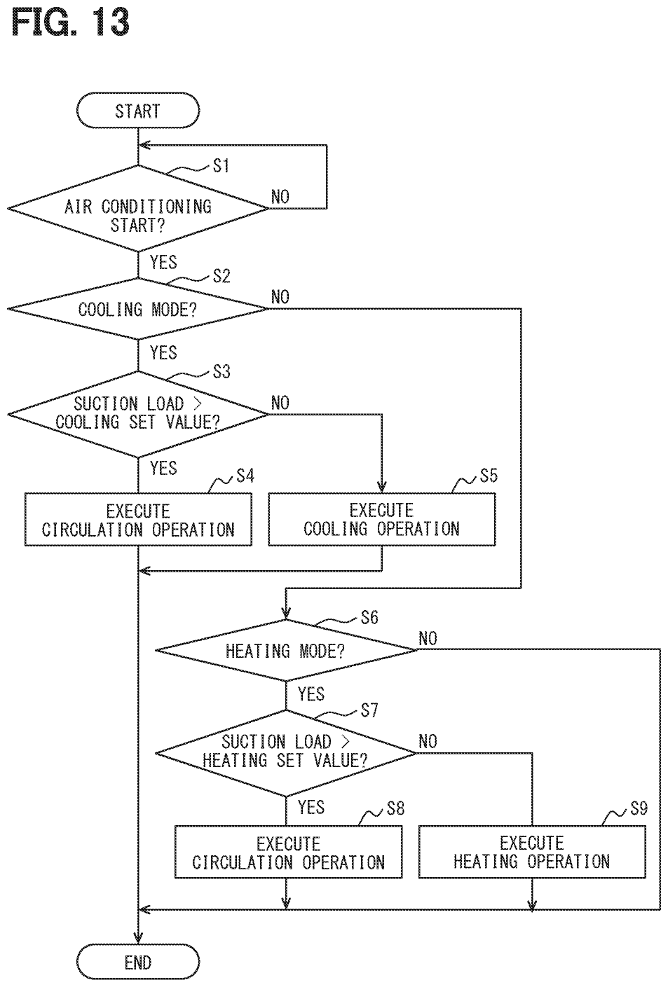

Next, the control contents of the vehicle cabin air conditioning system AS configured as described above will be described with reference to FIG. 13.

The flowchart shown in FIG. 13 represents the control contents for efficiently and promptly improving the comfort of the target space regarding the air conditioning operation of the seat air conditioner 1, and is executed by the air conditioning control unit 100 as a control program.

As shown in FIG. 1, the housing 10 of the seat air conditioner 1 is disposed between the seat bottom of the rear seat SB and the cabin floor surface F. Therefore, during the air conditioning operation of the seat air conditioner 1, as the air in the cabin C, the air between the seat bottom and the cabin floor surface F is sucked into the housing 10. Air in the cabin C is likely to stay between the seat bottom and the cabin floor surface F, and the temperature of air between the seat bottom and the cabin floor surface F may be different from the average temperature in the cabin C.

If the air between the seat bottom of the rear seat SB and the cabin floor surface F is not suitable for the air conditioning operation of the seat air conditioner 1, the seat air conditioner 1 may not be able to adjust the air to have a desired comfortable temperature.

For example, during a cool-down operation which is the initial stage of the air conditioning of the seat air conditioner 1, the temperature of the air between the seat bottom of the rear seat SB and the cabin floor surface F may be equal to or higher than the operating temperature range of the seat air conditioner 1. In this case, the seat air conditioner 1 cannot create a comfortable temperature during the cool-down operation.

If the temperature of the air between the seat bottom of the rear seat SB and the cabin floor surface F is lower than or equal to the operating temperature range of the seat air conditioner 1 during a warm-up operation which is the initial stage of air conditioning, the seat air conditioner 1 cannot create a comfortable temperature at the warm-up operation.

That is, in the vehicle cabin air conditioning system AS, the comfort of the passenger P may not be raised sufficiently until the temperature of the air between the seat bottom of the rear seat SB and the cabin floor surface F satisfies the condition at the initial stage of air conditioning.

In other words, in the vehicle cabin air conditioning system AS, it may take some time to improve the comfort of the passenger P in the initial stage of air conditioning. In this case, the air conditioning request of the passenger P is not sufficiently satisfied.

The control content shown in FIG. 13 is a control program executed to improve these points, and is stored in the ROM of the air conditioning control unit 100. The control program read by the CPU is executed when the vehicle cabin air conditioning system AS is powered on. At the start point, the air conditioning operation of the indoor air conditioner 60 may be performed or may be stopped.

As shown in FIG. 13, in step S1, it is determined whether the air conditioning operation in the vehicle cabin air conditioning system AS has started. The determination process of step S1 is executed based on, for example, an operation signal from the operation panel 101. If the air conditioning operation in the vehicle cabin air conditioning system AS has started, the process proceeds to step S2. If not, the process waits.

In step S2, it is determined whether the operation mode is the cooling mode regarding the air conditioning operation in the vehicle cabin air conditioning system AS. If the cooling mode is set, the process proceeds to step S3. If not, the process proceeds to step S6.

The determination process in step S2 may be performed, for example, by referring to the information on the operation mode set on the operation panel 101, the blowout temperature in the seat duct D, the temperature in the cabin C, or the temperature outside the cabin C.

In step S3, it is determined whether the suction load of the seat air conditioner 1 is larger than a cooling set value. The suction load is calculated using the detection result of the suction temperature sensor 107, and represents the enthalpy of air sucked from the warm air vent 12 and the cold air vent 13 as an index.

The air conditioning control unit 100, when calculating the suction load based on the detection result of the suction temperature sensor 107, functions as the suction load determination unit 100D. The enthalpy of suction air is calculated as the suction load. Alternatively, the temperature of suction air may be used as an index indicating the suction load.

The cooling set value indicates a threshold value for the suction load sucked from the warm air vent 12 and the cold air vent 13, at which the cold air CA can be supplied from the seat air conditioner 1 to the target space. The cooling set value indicates the suction load corresponding to the upper limit value in the operating temperature range of the seat air conditioner 1.

If the suction load is larger than the cooling set value, the process proceeds to step S4. If not, the process proceeds to step S5. The air conditioning control unit 100 performing the determination process of step S3 functions as the condition determination unit 100E.

When the process proceeds from step S3 to step S4, for example, the vehicle cabin air conditioning system AS may be performing a cool down control. In this case, since the low-temperature conditioned air A is not blown into the cabin C from the indoor air conditioner 60, the temperature of the cabin C is high. In particular, the air flow is likely to be stagnant in the lower part of the seat where the housing 10 of the seat air conditioner 1 is arranged, so that the thermal load on the air conditioning operation of the refrigeration cycle device 20 is high.

When the process proceeds to step S4, the operation of the seat air conditioner 1 is controlled to execute the circulation operation. Specifically, the air conditioning control unit 100 controls the operation of the seat air conditioner 1 to perform the circulation operation in which the air in the cabin C is circulated through the space between the rear seat SB and the cabin floor surface F. The air conditioning control unit 100 executing step S4 functions as the circulation operation control unit 100F.

Specifically, the air conditioning control unit 100 operates the second blower 31 in the state where the refrigeration cycle device 20 of the seat air conditioner 1 is stopped. As a result, in the seat air conditioner 1, the air between the rear seat SB and the cabin floor surface F is sucked into the housing 10 through the warm air vent 12 and the cold air vent 13 and exhausted from the exhaust port 16 into the cabin C.

When the circulation operation is executed in the vehicle cabin air conditioning system AS, the air between the seat bottom of the rear seat SB and the cabin floor surface F is agitated with the air in the cabin C, and the temperature of the suction air can be adjusted to have the average temperature of the air in the cabin C. That is, the circulation operation can reduce the suction load to an average thermal load of the air in the cabin C.

In step S4, the circulation operation is executed until, for example, the suction load becomes equal to or lower than the cooling set value. When the circulation operation ends, the control program ends. Then, the control program is periodically executed by the air conditioning control unit 100.

According to the vehicle cabin air conditioning system AS, the suction load of the seat air conditioner 1 is reduced to an average level in the cabin C by executing the circulation operation before starting the cooling operation of the seat air conditioner 1.

Therefore, the vehicle cabin air conditioning system AS can supply the cold air CA from the seat air conditioner 1 to the target space earlier compared with a case where the circulation operation is not executed. Thus, the comfort of the passenger P on the rear seat SB can be improved.

In step S5, since the suction load is equal to or lower than the cooling set value, the vehicle cabin air conditioning system AS executes the cooling operation. Specifically, the air conditioning control unit 100 operates the seat air conditioner 1 and the indoor air conditioner 60 in the cooling mode.

At this time, in the rear seat air conditioning unit 72 of the indoor air conditioner 60, the operation of the air volume adjusting door 81 is controlled so that the conditioned air A having the low temperature is blown out from at least the first outlet 79. As a result, the conditioned air A having the low temperature is supplied to the warm air vent 12 and the cold air vent 13 of the seat air conditioner 1 via the supply duct 90, so that the thermal load of the refrigeration cycle device 20 can be reduced during the cooling operation.

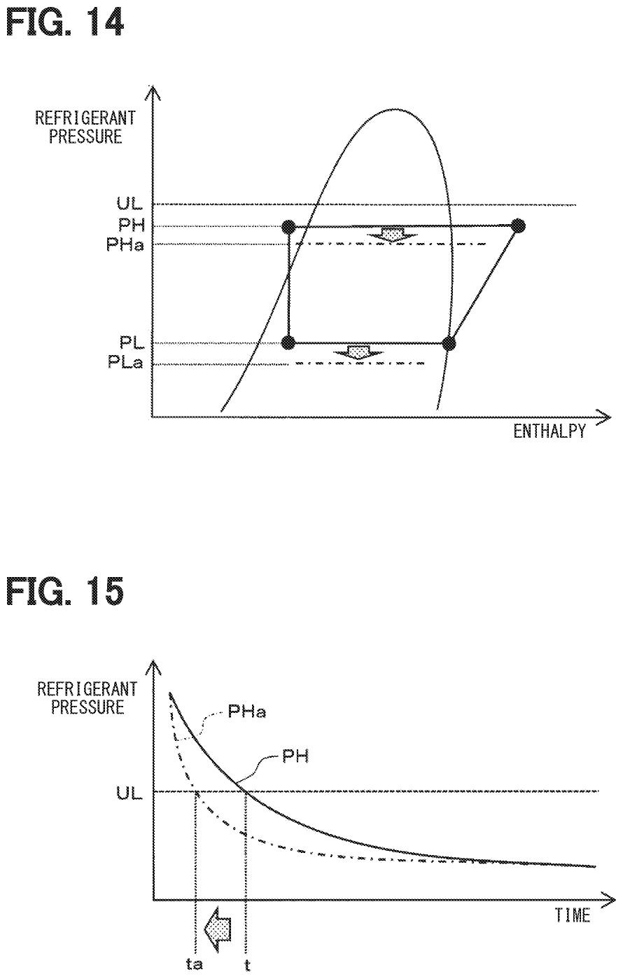

The influence of the supplying the conditioned air A in step S5 on the state of the refrigerant in the refrigeration cycle device 20 will be described with reference to FIGS. 14 and 15. FIG. 14 is a Mollier diagram relating to the refrigeration cycle device 20 of the seat air conditioner 1 in the cooling mode.

In FIG. 14, the high-pressure side refrigerant pressure is indicated by PH when the air in the cabin C is sucked in to perform the cooling operation, and the low-pressure side refrigerant pressure in this case is indicated by PL. The high-pressure side refrigerant pressure is indicated by PHa and the low-pressure side refrigerant pressure is indicated by PLa when the cooling operation is performed by sucking the conditioned air A having the low temperature.

As described above, the conditioned air A supplied to the warm air vent 12 and the cold air vent 13 is low-temperature air cooled in the vehicle cabin side refrigeration cycle 82 of the indoor air conditioner 60. Therefore, when the air is supplied to the cold air vent 13 of the seat air conditioner 1, the low-temperature conditioned air A is further cooled to a low temperature, since the low-pressure refrigerant flowing inside the evaporator 24 absorbs heat.

As shown in the Mollier diagram in FIG. 14, the low-pressure side refrigerant pressure of the refrigeration cycle device 20 is reduced from PL to PLa by supplying the conditioned air A having the low temperature to the cold air vent 13.

According to the vehicle cabin air conditioning system AS, in the cooling mode, the low-temperature conditioned air A is supplied from the cold air vent 13 to the evaporator 24 so that the conditioned air A pre-cooled by the indoor air conditioner 60 is further cooled in the evaporator 24. That is, the vehicle cabin air conditioning system AS can reduce the blowout temperature of the cold air CA supplied from the seat air conditioner 1 to the target space.

Then, when the air is supplied from the indoor air conditioner 60 to the warm air vent 12 of the seat air conditioner 1, the low-temperature conditioned air A exchanges heat with the high-pressure refrigerant flowing inside the condenser 22. The high-pressure side refrigerant pressure of the refrigeration cycle device 20 is reduced from PH to PHa by supplying the conditioned air A having the low temperature to the warm air vent 12.

As shown in the Mollier diagram in FIG. 14, the vehicle cabin air conditioning system AS improves the COP of the refrigeration cycle device 20 in the cooling mode by supplying the conditioned air A to the warm air vent 12.

Further, the seat air conditioner 1 in the cooling mode is configured so that the cooling operation cannot be performed unless the high-pressure side refrigerant pressure of the refrigeration cycle device 20 is lower than a predetermined upper limit pressure UL.

In this respect, according to the vehicle cabin air conditioning system AS, the low-temperature conditioned air A can be supplied to the warm air vent 12 to lower the high-pressure side refrigerant pressure of the cycle, so that the high-pressure side refrigerant pressure can be quickly lowered to be lower than the upper limit pressure limit UL.

The graph in FIG. 15 shows the time period taken until the high-pressure side refrigerant pressure decreases to the upper limit pressure UL. The time period to when the low-temperature conditioned air A is supplied to the warm air vent 12 is shorter than the time period t when the air in the cabin C is sucked.

That is, according to the vehicle cabin air conditioning system AS, the start time of the cooling operation in the seat air conditioner 1 can be made earlier by supplying the low-temperature conditioned air A to the warm air vent 12. As a result, the vehicle cabin air conditioning system AS can enhance the comfort of the passenger P in the target space of the rear seat SB earlier.

When the cooling operation of the vehicle cabin air conditioning system AS in step S5 ends, the air conditioning control unit 100 ends the control program. The air conditioning control unit 100 periodically executes the control program.

As shown in FIG. 13, when it is determined that the cooling mode is not set in step S2, the process proceeds to step S6. In step S6, it is determined whether the operation mode is the heating mode regarding the air conditioning operation in the vehicle cabin air conditioning system AS. The determination process in step S6 is determined using the same criteria as in step S2.

If the heating mode is set, the process proceeds to step S7. If not, the control program ends. For example, if the air mix mode is set, the control program may be ended.

In step S7, it is determined whether the suction load of the seat air conditioner 1 is smaller than the heating set value. The suction load is the enthalpy of the suction air calculated using the detection result of the suction temperature sensor 107, as in the case of step S3.

The heating set value indicates a threshold value with respect to the suction load sucked from the warm air vent 12 and the cold air vent 13, at which the warm air WA can be supplied from the seat air conditioner 1 to the target space. The heating set value indicates the suction load corresponding to the lower limit value in the operating temperature range of the seat air conditioner 1.

When the suction load is smaller than the heating set value, the process proceeds to step S8. If not, the process proceeds to step S9. The air conditioning control unit 100 performing the determination process of step S7 functions as the condition determination unit 100E.

When the process proceeds from step S7 to step S8, for example, the vehicle cabin air conditioning system AS may be performing warm-up control. In this case, the conditioned air A having high temperature is not blown into the cabin C from the indoor air conditioner 60, so the temperature of the cabin C is low. In particular, the air flow is likely to be stagnant in the lower part of the seat where the housing 10 of the seat air conditioner 1 is arranged, so that the thermal load on the refrigeration cycle device 20 is low.

In step S8, the operation of the seat air conditioner 1 is controlled to execute the circulation operation. Specifically, as in step S4, the air conditioning control unit 100 controls the operation of the seat air conditioner 1 so that the air in the cabin C is circulated through the space between the rear seat SB and the cabin floor surface F. The air conditioning control unit 100 executing step S8 functions as the circulation operation control unit 100F.

Specifically, the air conditioning control unit 100 operates the second blower 31 in the state where the refrigeration cycle device 20 of the seat air conditioner 1 is stopped. As a result, in the seat air conditioner 1, the air between the rear seat SB and the cabin floor surface F is sucked into the housing 10 through the warm air vent 12 and the cold air vent 13 and exhausted from the exhaust port 16 into the cabin C.

When the circulation operation is executed in the vehicle cabin air conditioning system AS, the air between the seat bottom of the rear seat SB and the cabin floor surface F is agitated with the air in the cabin C, and the suction temperature can be made close to the average temperature of the air in the cabin C. That is, the circulation operation can bring the suction load close to the average thermal load of the air in the cabin C.

In step S8, the circulation operation is executed until, for example, the suction load becomes equal to or higher than the heating set value. When the circulation operation ends, the control program ends. The control program is periodically executed by the air conditioning control unit 100.

According to the vehicle cabin air conditioning system AS, the suction load of the seat air conditioner 1 can be increased to an average level in the cabin C by performing the circulation operation before starting the heating operation of the seat air conditioner 1.

Therefore, the vehicle cabin air conditioning system AS can supply the warm air WA from the seat air conditioner 1 to the target space earlier as compared with a case where the circulation operation is not executed. Thus, the comfort of the passenger P on the rear seat SB can be improved.

In step S9, since the suction load is equal to or higher than the heating set value, the heating operation is executed by the vehicle cabin air conditioning system AS. Specifically, the air conditioning control unit 100 operates the seat air conditioner 1 and the indoor air conditioner 60 in the heating mode.

At this time, in the rear seat air conditioning unit 72 of the indoor air conditioner 60, the operation of the air volume adjusting door 81 is controlled so that the conditioned air A with the high temperature is blown out from at least the first outlet 79. As a result, the conditioned air A with the high temperature is supplied to the warm air vent 12 and the cold air vent 13 of the seat air conditioner 1 through the supply duct 90, so as to reduce the thermal load of the refrigeration cycle device 20 during the heating operation.

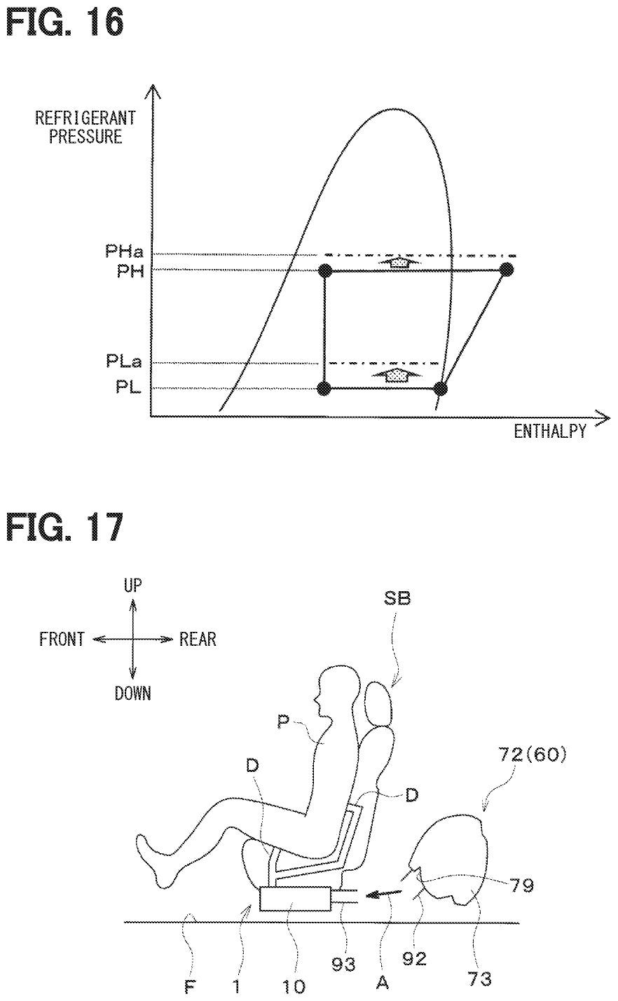

The influence of supplying the conditioned air A in step S9 on the state of the refrigerant in the refrigeration cycle device 20 will be described with reference to FIG. 16. FIG. 16 is a Mollier diagram relating to the refrigeration cycle device 20 of the seat air conditioner 1 in the heating mode.

In FIG. 16, the high-pressure side refrigerant pressure is indicated by PH when the air in the cabin C is sucked in to perform the heating operation, and the low-pressure side refrigerant pressure in this case is indicated by PL. The high-pressure side refrigerant pressure is shown by PHa and the low-pressure side refrigerant pressure is shown by PLa when the heating operation is performed by sucking the conditioned air A with the high temperature.

As described above, the conditioned air A supplied to the warm air vent 12 and the cold air vent 13 is high-temperature air heated in the vehicle cabin side refrigeration cycle 82 of the indoor air conditioner 60. Therefore, when the high-temperature conditioned air A is introduced into the warm air vent 12, the condenser 22 radiates the heat of the high-pressure refrigerant in the condenser 22 to the high-temperature conditioned air A, to further heat the conditioned air A.

That is, the vehicle cabin air conditioning system AS supplies the conditioned air A having the high temperature to the warm air vent 12 in the heating mode, so that the temperature of the warm air WA supplied from the seat air conditioner 1 to the target space can be raised.

When the air is supplied to the cold air vent 13 of the seat air conditioner 1, the high-temperature conditioned air A exchanges heat with the low-pressure refrigerant flowing through the evaporator 24. As a result, as shown in the Mollier diagram in FIG. 16, the low-pressure side refrigerant pressure of the refrigeration cycle device 20 rises from PL to PLa by supplying the conditioned air A having the low temperature to the cold air vent 13.

That is, according to the vehicle cabin air conditioning system AS, the COP of the refrigeration cycle device 20 in the heating mode can be improved by introducing the high-temperature conditioned air A into the cold air vent 13 in the heating mode.

Further, an increase in the low-pressure side refrigerant pressure of the cycle during a heating operation means an increase in the density of suction refrigerant in the compressor 21. That is, in the heating mode of the seat air conditioner 1, the flow rate of the refrigerant circulating in the refrigeration cycle device 20 increases, so that the vehicle cabin air conditioning system AS can improve the heating performance of the seat air conditioner 1.

Therefore, it is possible to execute the heating operation of the seat air conditioner 1 by introducing the conditioned air A with the high temperature, even in case where the blowout temperature of the seat air conditioner 1 is too low to operate in the heating mode.

That is, according to the vehicle cabin air conditioning system AS, the heating operation can be started earlier by introducing the conditioned air A with the high temperature into the warm air vent 12 and the cold air vent 13 of the seat air conditioner 1, compared with a case where the air in the cabin C is introduced. Thus, the comfort of the passenger P can be improved.

When the heating operation of the vehicle cabin air conditioning system AS in step S9 ends, the air conditioning control unit 100 ends the control program. The air conditioning control unit 100 periodically executes the control program.

As described above, according to the vehicle cabin air conditioning system AS of the present embodiment, the temperature of air sucked into the housing 10 by the first blower 30 and the second blower 31 of the seat air conditioner 1 from the warm air vent 12 and the cold air vent 13 can be adjusted by the refrigeration cycle device 20. Further, according to the vehicle cabin air conditioning system AS, the comfort of the target space can be improved by the seat air conditioner 1 by supplying the temperature-adjusted air to the target space.

According to the vehicle cabin air conditioning system AS, the conditioned air A whose temperature is adjusted in the vehicle cabin side refrigeration cycle 82 of the indoor air conditioner 60 to reduce the thermal load of the seat air conditioner 1 is supplied to the warm air vent 12 and the cold air vent 13 via the supply duct 90. As a result, the vehicle cabin air conditioning system AS can efficiently improve the comfort due to the seat air conditioner 1.

Further, according to the vehicle cabin air conditioning system AS, the conditioned air A that has passed through the indoor air conditioner 60 can be guided to the warm air vent 12 and the cold air vent 13 in the initial stage of the air conditioning operation such as heating or cooling. In the vehicle cabin air conditioning system AS, the refrigeration cycle device 20 performs temperature adjustment using the conditioned air A whose temperature has been adjusted so as to reduce the thermal load on the seat air conditioner 1. Therefore, it is possible to improve comfort in the target space quickly.

The refrigeration cycle device 20 of the seat air conditioner 1 has the compressor 21, the condenser 22, the pressure reducing unit 23, and the evaporator 24. The vehicle cabin air conditioning system AS supplies the conditioned air A whose temperature is adjusted by the indoor air conditioner 60 so as to reduce the thermal load of the seat air conditioner 1 via the supply duct 90 to one of the condenser 22 and the evaporator 24.

As a result, the vehicle cabin air conditioning system AS can effectively perform the temperature adjustment by the refrigeration cycle device 20 using the conditioned air A appropriately adjusted in the temperature. Thus, it is possible to efficiently improve the comfort of the target space of the rear seat SB.

When supplying the cold air CA from the seat air conditioner 1 to the target space in the cooling mode, the vehicle cabin air conditioning system AS supplies the low-temperature conditioned air A cooled in the vehicle cabin side refrigeration cycle 82 to the warm air vent 12 of the seat air conditioner 1 via the supply duct 90.

As a result, the low-temperature conditioned air A is supplied to the condenser 22 of the seat air conditioner 1, so that the high-pressure side refrigerant pressure in the refrigeration cycle device 20 is reduced, as shown in FIGS. 14 and 15, by the cold heat of the conditioned air A.

That is, according to the vehicle cabin air conditioning system AS, in the cooling mode, the low-temperature conditioned air A is supplied to the warm air vent 12 to improve the COP of the refrigeration cycle device 20 during the cooling operation. The start time of the cooling operation of the seat air conditioner 1 can be made earlier.

When the warm air WA is supplied from the seat air conditioner 1 to the target space in the heating mode of step S9, the vehicle cabin air conditioning system AS supplies the high-temperature conditioned air A heated by the vehicle cabin side refrigeration cycle 82 to the cold air vent 13 of the seat air conditioner 1 via the supply duct 90.

As a result, the conditioned air A with the high temperature is supplied to the evaporator 24 of the seat air conditioner 1, so that the low-pressure side refrigerant pressure in the refrigeration cycle device 20 can be raised by the warm heat of the conditioned air A as shown in FIG. 16.

That is, according to the vehicle cabin air conditioning system AS, the COP of the refrigeration cycle device 20 during the heating operation is improved by supplying the high-temperature conditioned air A to the cold air vent 13 in the heating mode. Thus, the heating operation of the seat air conditioner 1 can be started earlier.

Further, as shown in FIG. 13, when it is determined in step S3 and step S7 that the suction load in the seat air conditioner 1 satisfies a predetermined condition, the vehicle cabin air conditioning system AS executes the circulation operation using the seat air conditioner 1 at step S4 and step S8.

According to the vehicle cabin air conditioning system AS, the circulation operation using the seat air conditioner 1 is executed to suppress the accumulation of air around the seat air conditioner 1 and to produce a flow of air circulating in the cabin C.

As a result, the vehicle cabin air conditioning system AS can adjust the air conditioning thermal load of the refrigeration cycle device 20, regarding the air around the seat air conditioner 1, to an average state of air inside the cabin C. As a result, the vehicle cabin air conditioning system AS can improve the comfort by the seat air conditioner 1 earlier.

Further, according to the vehicle cabin air conditioning system AS, the seat air conditioner 1 is configured to perform an air conditioning operation for the target space defined in the rear seat SB, so that the comfort of the passenger P seated in the rear seat SB can be certainly improved.

Since the housing 10 of the seat air conditioner 1 is disposed between the seat bottom of the seat such as the rear seat SB and the cabin floor surface F, the retention of air is likely to occur in the area around the housing 10 in the cabin C. According to the vehicle cabin air conditioning system AS, the comfort can be improved by the seat air conditioner 1 even if the seat air conditioner 1 is arranged in this way.

The present disclosure is not limited to the embodiments described above, and various modifications can be made as follows within a scope not departing from the spirit of the present disclosure.

In the above-described embodiment, the seat air conditioner to condition air for the seat is described as an example of the individual air conditioner, but is not limited to this. The present disclosure can be applied to a device that intensively conditions air for a space, which is a part of the cabin C.

In the above-described embodiment, the conditioned air A from the indoor air conditioner 60 that functions as a thermal load reducing unit is guided to the seat air conditioner 1 using the supply duct 90, but is not limited to this.

For example, as shown in FIG. 17, a supply guide member 92 and a suction assisting portion 93 may be provided, instead of the supply duct 90. In this case, the supply guide member 92 is formed in a tubular shape surrounding the first outlet 79 of the rear seat air conditioning unit 72, and is preferably configured to extend toward the warm air vent 12 and the cold air vent 13 of the seat air conditioner 1.

The suction assisting portion 93 is located at the opening edges of the warm air vent 12 and the cold air vent 13 of the seat air conditioner 1, and is preferably provided to guide the conditioned air A from the supply guide member 92 to the warm air vent 12 and the cold air vent 13. Even with the configuration shown in FIG. 17, the same effects as those of the vehicle cabin air conditioning system AS of the embodiment can be expected.

In the above-described embodiment, the supply duct 90 is located above the cabin floor surface F to connect the first outlet 79 of the indoor air conditioner 60 to the warm air vent 12 and the cold air vent 13 of the seat air conditioner 1, but the route of the supply duct 90 is not limited to this.

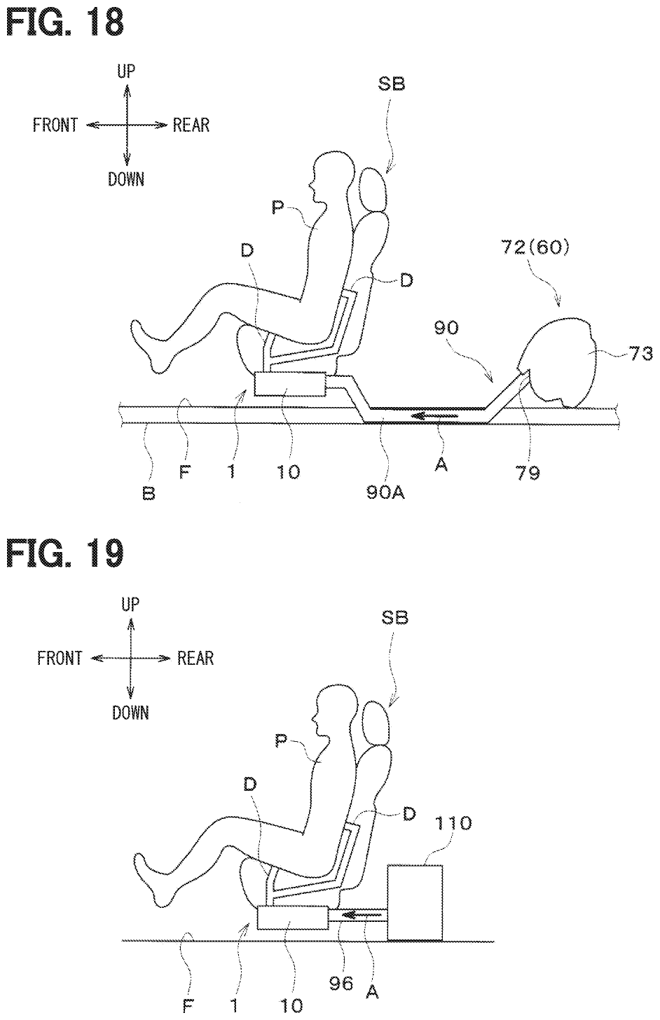

For example, as shown in FIG. 18, it is also possible to provide an underfloor passage 90A as a part of the supply duct 90. The underfloor passage 90A is arranged and positioned between the vehicle body B which comprises an outer member of the hybrid vehicle and the cabin floor surface F which is an inner member of the cabin C.

According to the vehicle cabin air conditioning system AS, the space occupied by the supply duct 90 in the cabin C is reduced by arranging the underfloor passage 90A in a part of the supply duct 90, so as to secure a space for the passenger P in the cabin C. Further, since the vehicle body B and the cabin floor surface F can be partially used as the underfloor passage 90A, it is possible to suppress an increase in the number of components.

In the above embodiment, the indoor air conditioner 60 is used as the thermal load reducing unit, but is not limited to this. Various devices can be adopted to reduce the air conditioning thermal load of the refrigeration cycle device 20 with respect to the suction air during the air conditioning operation of the seat air conditioner 1.

For example, as shown in FIG. 19, a heater 110 may be used instead of the rear seat air conditioning unit 72 of the indoor air conditioner 60. In this case, the heater 110 preferably has a blower fan that blows air toward the seat air conditioner 1, and a heating unit that heats the air blown by the blower fan.

Accordingly, it is possible to supply high-temperature air to the warm air vent 12 and the cold air vent 13 of the seat air conditioner 1, so that the heating performance of the seat air conditioner 1 is improved in the heating mode.

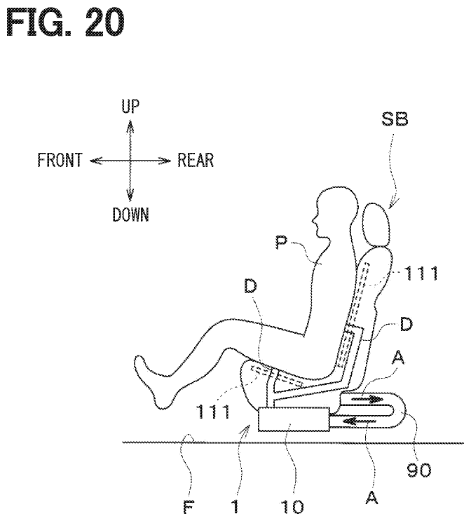

Further, as shown in FIG. 20, it is also possible to use a seat heater 111 arranged on the surface of the seat bottom or backrest of the seat (for example, the rear seat SB) as a thermal load reducing unit.

In this case, the seat bottom and the backrest have a cushioning material such as cushion with a certain degree of air permeability. The seat heater 111 is made of a material having a high thermal conductivity in a thin plate shape, and generates heat when receiving power supply.

In this case, one end of the supply duct 90 is connected to the seat bottom or backrest of the seat, and the other end of the supply duct 90 is connected to the warm air vent 12 and the cold air vent 13 of the seat air conditioner 1.

Therefore, according to the configuration of FIG. 20, the air warmed by the seat heater 111 is sucked from the backrest and seat bottom, and can be led to the warm air vent 12 and the cold air vent 13 of the seat air conditioner 1 through the supply duct 90.

As a result, according to the configuration shown in FIG. 20, it is possible to supply high-temperature air to the warm air vent 12 and the cold air vent 13 of the seat air conditioner 1. Thus, the heating performance of the seat air conditioner 1 can be improved in the heating mode.

In the above-described embodiment, in order to shorten the path of the supply duct 90, the seat air conditioner 1 is attached to the rear seat SB and the supply duct 90 is connected to the first outlet 79 of the rear seat air conditioning unit 72, but is not limited to this.

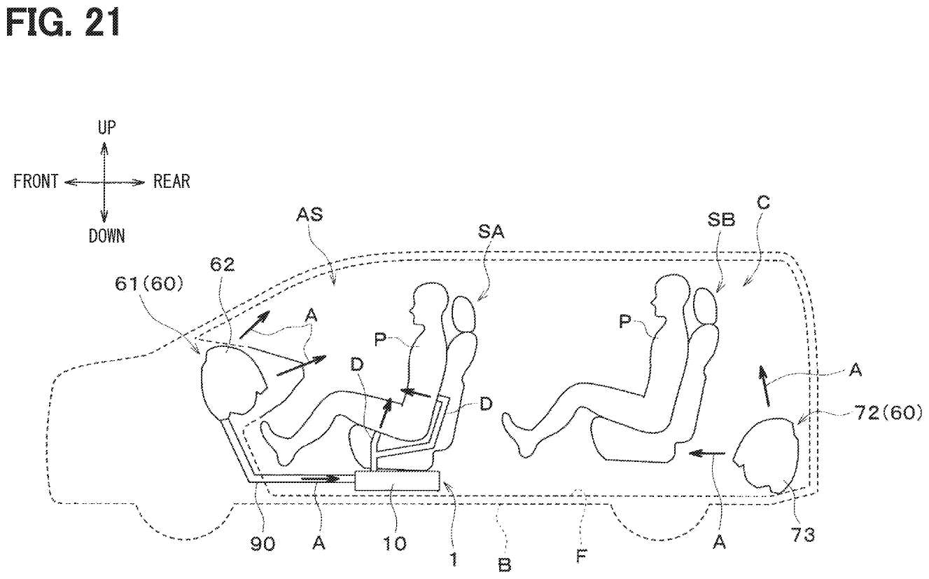

That is, as shown in FIG. 21, the vehicle cabin air conditioning system AS can be configured by the seat air conditioner 1 attached to the front seat SA and the front seat air conditioning unit 61 of the indoor air conditioner 60.

In this case, one end of the supply duct 90 is connected to at least one of plural outlets of the front seat air conditioning unit 61, and the other end is connected to the warm air vent 12 and/or the cold air vent 13 of the seat air conditioner 1.

With such a configuration, the conditioned air A is supplied from the front seat air conditioning unit 61 while the path of the supply duct 90 is made as short as possible. Thus, the comfort of the target space in the front seat SA is efficiently improved.

Further, the seat air conditioner 1 for the rear seat SB and the front seat air conditioning unit 61 may be connected with each other by the supply duct 90, or the seat air conditioner 1 for the front seat SA and the rear seat air conditioning unit 72 may be connected with each other by the supply duct 90. In this case, if the underfloor passage 90A is provided in a part of the supply duct 90, a space in the cabin C can be secured even if the path of the supply duct 90 is long.

In the above-described embodiment, the housing 10 of the seat air conditioner 1 is attached to the bottom surface of the seat (for example, the rear seat SB), and is movable inside the cabin C back and forth as the seat slides, but is not limited to this.

For example, the housing 10 of the seat air conditioner 1 may be fixed to the cabin floor surface F. In this case, it is desirable to use a duct having a certain degree of flexibility and elasticity such as a flexible duct, as a duct that connects the supply port 14 of the housing 10 and the seat duct D.

In the above-described embodiment, the refrigeration cycle device 20 is used to generate cold heat and warm heat in parallel in the seat air conditioner 1, but is not limited to this. For example, instead of the refrigeration cycle device 20, it is possible to employ a Peltier element to generate cold heat and warm heat in parallel.

Although the present disclosure has been described in accordance with the embodiments, it is understood that the present disclosure is not limited to the embodiments and structures disclosed therein. The present disclosure also includes various modifications and variations within an equivalent range. In addition, while the various combinations and configurations, which are preferred, other combinations and configurations, including more, less or only a single element, are also within the spirit and scope of the present disclosure.

What is claimed is:

1. A vehicle cabin air conditioning system comprising:
an individual air conditioner that conditions air in a target space predetermined inside a cabin, the individual air conditioner including
a blower disposed inside a housing,
a suction port to suck air into the housing when the blower operates,
a heat generator disposed in the housing to simultaneously generate cold heat for cooling air blown by the blower and warm heat for heating the air, and
a supply port to supply at least one of a cold air cooled with the cold heat generated by the heat generator and a warm air heated with the warm heat generated by the heat generator to the target space outside the housing;
a thermal load reducing unit configured to adjust a temperature of the air sucked from the suction port in order to reduce a thermal load in the heat generator;
a supply flow path configured to guide the air controlled in temperature by the thermal load reducing unit to the suction port;
a suction load determination unit that specifies a suction load that is an air conditioning thermal load of air sucked into the housing from the suction port;
a condition determination unit that determines whether a predetermined load condition is satisfied using the suction load and an air conditioning thermal load of air in the cabin in an initial stage of an air conditioning operation; and
a circulation operation control unit that controls operation of the blower so as to circulate the air in the cabin, when the condition determination unit determines that the load condition is satisfied, by drawing in air in the cabin from the suction port into the housing and sending the air into the cabin from the housing via an exhaust port.

2. The vehicle cabin air conditioning system according to claim 1, wherein
the heat generator is a refrigeration cycle device comprising: a compressor to compress and discharge refrigerant; a condenser to radiate heat of high-pressure refrigerant compressed by the compressor to generate the warm heat; a decompressor to decompress the refrigerant flowing out from the condenser; and an evaporator that causes the refrigerant decompressed in the decompressor to absorb heat to generate the cold heat, and
the thermal load reducing unit supplies the air controlled in temperature by the thermal load reducing unit to at least one of the condenser and the evaporator via the suction port.

3. The vehicle cabin air conditioning system according to claim 2, wherein
the thermal load reducing unit supplies the air cooled by the thermal load reducing unit to the condenser in the heat generator when the cold air is supplied from the supply port to the target space.

4. The vehicle cabin air conditioning system according to claim 2, wherein
the thermal load reducing unit supplies the air heated by the thermal load reducing unit to the evaporator in the heat generator when the warm air is supplied from the supply port to the target space.

5. The vehicle cabin air conditioning system according to claim 1, wherein
the individual air conditioner is a seat air conditioner that conditions air in the target space defined for a seat arranged in the cabin, and
the housing is disposed between a seat bottom of the seat and a floor surface of the cabin.
